(19) United States
(12) Patent Application Publication
(10) Pub. No.: US 2005/0265362 A1
(43) Pub. Date: Dec. 1, 2005

(54) Message relay program and message relay device

(75) Inventors: Takahiko Kawashima, Kawasaki (JP); Isamu Kawamura, Kawasaki (JP)

Correspondence Address: Patrick G. Burns, Esq.;GREER, BURNS & CRAIN, LTD., 300 South Wacker Dr., Suite 2500, Chicago, IL, 60606, US

(73) Assignee: FUJITSU LIMITED

(21) Appl. No.: 10/964,534

(22) Filed: Oct. 13, 2004

(30) Foreign Application Priority Data
Apr. 16, 2004 (JP) 2004-121959

(51) Int. Cl. H04L 12/56

(52) U.S. Cl. 370/401

(57) ABSTRACT

A message relay program which increases the multiplicity of message-relay processing functions before the number of concurrently processed processing-request messages becomes too great. Message-relay processing units receive processing-request messages from clients, and transform each processing-request message so as to have a predetermined data structure, and transfer the transformed processing-request messages to processing execution units. In addition, when the message-relay processing units receive from the processing execution units processing-result messages corresponding to the processing-request messages, the processing-result messages are transferred to the clients. Further, when the number of processing-request messages which are concurrently being processed by the message-relay processing units exceeds a predetermined threshold value, a predetermined number of additional message-relay processing units are newly started.

### CROSS-REFERENCE TO RELATED APPLICATIONS

This application is based upon and claims priority of Japanese Patent Application No. 2004-121959, filed on Apr. 16, 2004, the contents being incorporated herein by reference.

### BACKGROUND OF THE INVENTION

1) Field of the Invention

The present invention relates to a message relay program and a message relay device for use in a computer which relays messages exchanged between programs, and in particular to a message relay program and a message relay device which have a function of automatically changing the multiplicity of processing.

2) Description of the Related Art

With the increase in the transaction processing using computers, the necessity of connection between individually developed functions is increasing. However, messages having individually defined data structures are used in input to and output from the respective functions. That is, the data structures of inputted or outputted messages are not unified.

In order to address the above problem, message relay devices for relaying messages exchanged between functions have been proposed. Each message relay device transforms the data structure of each message outputted from a first function as a source into a data structure which can be handled by a second function as a destination, and inputs the message to the second function. Therefore, messages can be exchanged between two functions which are individually developed, and processing in which the two functions are associated with each other is enabled.

For example, a message relay device is arranged adjacent to a server which controls processing for all of transactions. When a client in which messages are defined with a format different from a format defined in the server sends a message to the message relay device, the message relay device transforms the data structure of the message received from the client, and inputs the message into the server. Thereafter, when the message relay device receives a response message from the server, the message relay device transforms the data structure of the response message, and sends the response to the client.

When a message relay device receives requests from clients and returns responses as described above, the requests from the clients may be concurrently received by the message relay device. Therefore, message-relay processing functions may be executed in a multiplexed manner. In this case, each of the multiplexed message-relay processing functions individually establishes a connection to a client, and receives a processing-request message.

When the message relay device concurrently receives processing-request messages, and the number of the processing-request messages exceeds a preset value of the multiplicity of the message-relay processing functions, generally, the message relay device sends to the clients which have sent the processing-request messages, an error message that a processing-request message cannot be received. In the case where the message-relay processing functions have a wait queue, processing-request messages are temporarily stored in the wait queue. When a message-relay processing function returns a response to a request which is currently under execution, and comes into a state in which the message-relay processing function can receive a request for processing, the message-relay processing function extracts a processing-request message from the wait queue, and executes processing.

However, when messages for requesting processing are stored in the wait queue, the times which the clients have to wait for response increase. Therefore, it is desirable that the number of processing-request messages stored in the wait queue is minimized. In order to eliminate the times for which processing-request messages are stored in the wait queue, it is necessary that portions of the message relay device which realize the message-relay processing functions operate with a multiplicity corresponding to the maximum number of processing-request messages which can be concurrently processed.

Incidentally, some processing functions executed in a server can be started in response to clients' requests. For such processing functions, some techniques which enable change in the number of processes or threads have been proposed.

For example, in some proposed server computers (for example, as disclosed in Japanese Unexamined Patent Publication No. 5-12226), server processes are generated or removed based on the number of requests issued from client computers and a load condition defined in a server-control-information storage portion.

In other proposed techniques (for example, as disclosed in Japanese Unexamined Patent Publication No. 7-152590), threads for executing clients' requests are created in response to the requests. When the number of the threads in a master process exceeds a predetermined value, a slave process is created so that the slave process succeeds in processing which has been executed by the master process. Thus, the number of processing functions which can be executed in parallel in response to requests from the clients can be increased.

However, the message-relay processing functions are required to be started in advance and wait for reception of requests from the clients. Therefore, it is impossible to adopt the techniques as disclosed in JPP Nos. 5-12226 and 7-152590, in which processing functions in a server are built up after an excessive number of processing requests are actually received. Thus, connections are established in advance between the message-relay processing functions and the clients, and the message-relay processing functions receive processing-request messages, and send processing-request messages indicating processing results, through the connections established in advance. Therefore, when a plurality of clients transmit processing-request messages, a message-relay processing function is required to exist in advance in correspondence with each client so that a connection between the client and the message-relay processing function can be established in advance.

In addition, when the number of processing-request messages which concurrently occur is too great, and a portion of the processing-request messages is stored in a wait queue provided for an arbitrary message-relay processing function, it is necessary to return a processing-request message indicating a processing result as a response to each processing-request message through a connection through which the processing-request message is received. Therefore, even when a process realizing a message-relay processing function is newly started after a processing-request message is stored in a wait queue, it is impossible to make the newly started process execute processing of the processing-request message stored in the wait queue.

As explained above, in message relay devices which require establishment of connections with clients, it is impossible to prevent increase in the clients' waiting time caused by storage of processing-request messages in wait queues, by increasing the number of message-relay processing functions after the number of processing-request messages which are required to be concurrently processed becomes too great.

Further, in order to eliminate the times for which processing-request messages are stored in a wait queues in a message relay device, a technique of making the message relay device operate with a multiplicity corresponding to the maximum number of concurrently inputted processing-request messages is known. However, in this case, the utilization efficiency of resources such as a memory decreases. That is, even when the number of concurrently inputted processing-request messages does not reach the maximum number, the message-relay processing functions (threads or processes) which are prepared in correspondence with the maximum number of concurrently inputted processing-request messages operate at all times. Therefore, a storage device (such as a main memory) in the message relay device is inefficiently used.

### SUMMARY OF THE INVENTION

The present invention is made in view of the above problems, and the object of the present invention is to provide a message relay program and a message relay device which can increase the multiplicity of message-relay processing functions before the number of processing-request messages which are required to be concurrently processed becomes too great.

In order to accomplish the above object, a message relay program is provided for relaying messages from at least one client by using a computer which is linked with the at least one client through at least one connection. The message relay program makes the computer execute processing comprising the steps of: (a) starting at least one first message-relay processing unit, where the number of the at least one first message-relay processing unit is predetermined; and (b) newly starting at least one second message-relay processing unit when the number of processing-request messages which are concurrently being processed by the at least one first message-relay processing unit exceeds a predetermined threshold value, where the number of the at least one second message-relay processing unit is predetermined. The at least one first message-relay processing unit and the at least one second message-relay processing unit receive processing-request messages from the at least one client, transform the processing-request messages so as to have a predetermined data structure, transfer the transformed processing-request messages to a processing execution device, receive from the processing execution device processing-result messages respectively corresponding to the processing-request messages, and transfer the received processing-result messages to the at least one client.

Further, in order to accomplish the aforementioned object, a message relay device for relaying messages from at least one client which is linked with the message relay device through at least one connection is provided. The message relay device comprises: at least one first message-relay processing unit which is active; and a message-relay-processing starting unit which newly starts at least one second message-relay processing unit when the number of processing-request messages which are concurrently being processed by the at least one first message-relay processing unit exceeds a predetermined threshold value. The number of the at least one second message-relay processing unit which is newly started by the message-relay-processing starting unit is predetermined, and the at least one first message-relay processing unit and the at least one second message-relay processing unit receive processing-request messages from the at least one client, transform the processing-request messages so as to have a predetermined data structure, transfer the transformed processing-request messages to a processing execution device, receive from the processing execution device processing-result messages respectively corresponding to the processing-request messages, and transfer the received processing-result messages to the at least one client.

The above and other objects, features and advantages of the present invention will become apparent from the following description when taken in conjunction with the accompanying drawings which illustrate preferred embodiment of the present invention by way of example.

### BRIEF DESCRIPTION OF THE DRAWINGS

FIG. 1 is a conceptual diagram illustrating the present invention which is realized in embodiments.

FIG. 2 is a diagram illustrating an example of a construction of a system of a first embodiment of the present invention.

FIG. 3 is a diagram illustrating an example of a hardware construction of a message relay device used in the first embodiment.

FIG. 4 is a diagram illustrating messages flowing between a gateway and the message-relay processing device.

FIG. 5 is a diagram illustrating constructions of the message-relay processing units.

FIG. 6 is a diagram illustrating state transitions in a message-relay processing unit.

FIG. 7 is a diagram illustrating loop processing for updating and referring to a shared area.

FIG. 8 is a diagram illustrating an example of a data structure of a configuration file.

FIG. 9 is a flow diagram illustrating processing performed when a message-relay-processing starting unit is started.

FIG. 10 is a flow diagram illustrating a processing sequence of a gateway when the gateway receives a processing-request message.

FIG. 11 is a flow diagram illustrating a sequence of processing performed by a message-relay processing unit when the message-relay processing unit receives a processing-request message which is to be stored in a wait queue.

FIG. 12 is a flow diagram illustrating a sequence of processing performed by the message-relay processing unit.

FIG. 13 is a flow diagram illustrating a sequence of processing performed by a message-relay-processing starting unit for monitoring the processing statuses of the message-relay processing units.

FIG. 14 is a flow diagram illustrating a sequence of processing for stopping operation of at least one message-relay processing unit.

FIG. 15 is a diagram illustrating a performance-deterioration phenomenon caused by a waiting time in a wait queue.

FIG. 16 is a diagram illustrating the amount of memory used in the case where message-relay processing units in correspondence with the maximum number of connections are multiplexed at all times.

FIG. 17 is a diagram illustrating the amount of memory used in the case where message-relay processing units are multiplexed according to the first embodiment.

FIG. 18 is a diagram illustrating an example of a construction of a system of a second embodiment of the present invention.

FIG. 19 is a diagram illustrating an example of a construction of a system of a third embodiment of the present invention.

FIG. 20 is a diagram illustrating an example of a construction of a system of a fourth embodiment of the present invention.

FIG. 21 is a flow diagram illustrating processing for updating a configuration file according to the fourth embodiment.

### DESCRIPTION OF THE PREFERRED EMBODIMENTS

Embodiments of the present invention are explained in detail below with reference to drawings.

First, an outline of the present invention which is realized in the embodiments is explained, and thereafter details of the embodiments are explained.

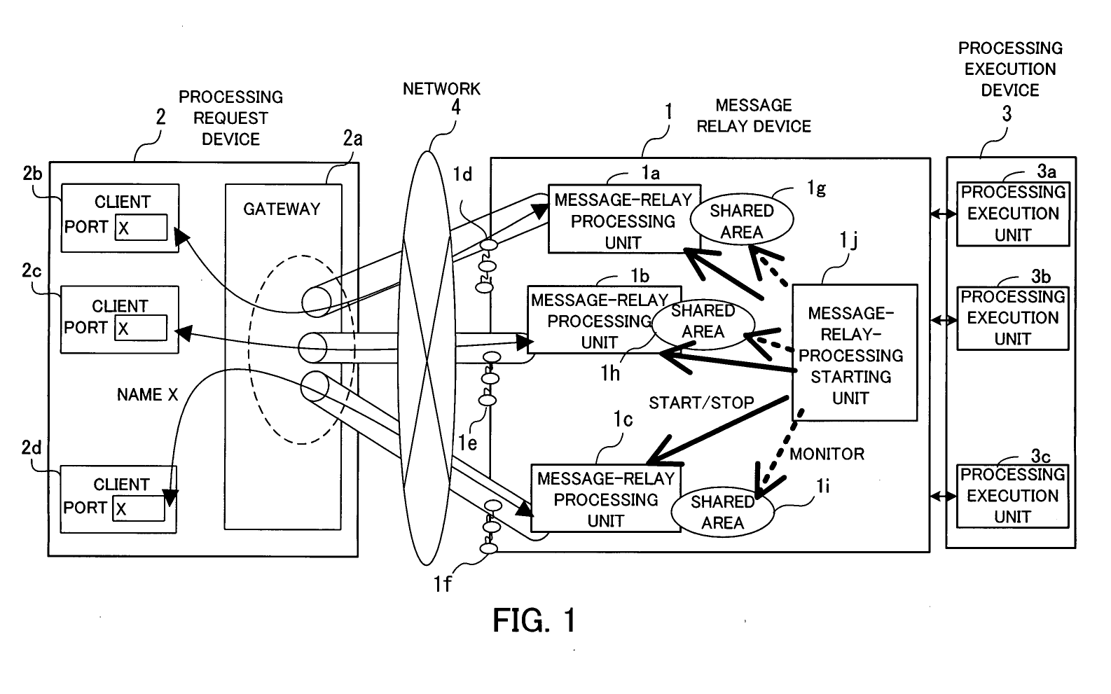

FIG. 1 is a conceptual diagram illustrating the present invention which is realized in the embodiments. The message relay device 1 according to the present invention is provided between a processing request device 2 and a processing execution device 3, and is connected to the processing request device 2 through a network 4.

The message relay device 1 comprises a plurality of message-relay processing units 1a, 1b, and 1c and a message-relay-processing starting unit 1j. The message-relay processing units 1a, 1b, and 1c receive processing-request messages from clients 2b, 2c, and 2d, transform the processing-request messages so as to have a predetermined data structure, and transfer the transformed processing-request messages to processing execution units 3a, 3b, and 3c, which execute processing in accordance with the processing-request messages. In addition, when the message-relay processing units 1a, 1b, and 1c receive from the processing execution units 3a, 3b, and 3c processing-result messages corresponding to the processing-request messages, the message-relay processing units 1a, 1b, and 1c transfer the processing-result messages to the clients.

Further, the message-relay processing units 1a, 1b, and 1c can be provided with wait queues 1d, 1e, and 1f. The wait queues 1d, 1e, and 1f are provided in communication buffers located between the message-relay processing units 1a, 1b, and 1c and a gateway 2a. When the number of active message-relay processing units is maximized, and the number of processing-request messages which are concurrently inputted into the active message-relay processing units exceeds the number of the active message-relay processing units, the excessive processing-request messages are stored in the wait queues 1d, 1e, and 1f, and processed one by one by the corresponding message-relay processing units 1a, 1b, and 1c.

Furthermore, the message-relay processing units 1a, 1b, and 1c can have shared areas 1g, 1h, and 1i, respectively. The shared areas 1g, 1h, and 1i are memory areas which can be shared with the message-relay-processing starting unit 1j. In the shared areas 1g, 1h, and 1i, information indicating operational statuses of the message-relay processing units 1a, 1b, and 1c (e.g., information indicating whether or not each of the message-relay processing units 1a, 1b, and 1c is currently processing of a processing-request message) is set.

When the number of processing-request messages which are concurrently being processed by the message-relay processing units 1a, 1b, and 1c exceeds a threshold value for increase, the message-relay-processing starting unit lj newly starts at least one message-relay processing unit, where the number of the at least one message-relay processing unit is predetermined. For example, the message-relay-processing starting unit 1j can recognize the number of processing-request messages which are concurrently being processed, by monitoring the shared areas 1g, 1h, and 1i in the message-relay processing units 1a, 1b, and 1c. The above threshold value for increase is a number which is slightly smaller than the number of message-relay processing units which are already started.

The processing request device 2 includes the gateway 2a and the clients 2b, 2c, and 2d. The clients 2b, 2c, and 2d output processing-request messages according to users' manipulation inputs and the like. The gateway 2a establishes connections between the gateway 2a and the message-relay processing units 1a, 1b, and 1c, and then transmits the processing-request messages which are outputted from the clients 2b, 2c, and 2d, to one or more message-relay processing units which are ready to process processing-request messages.

The gateway 2a can recognize a message-relay processing unit which is currently ready to process a processing-request message, for example, based on whether or not each of the message-relay processing units 1a, 1b, and 1c has already returned a processing-result message in response to a processing-request message. That is, it is possible to determine that one of the message-relay processing units 1a, 1b, and 1c is processing a processing-request message after transmission of the processing-request message to the one of the message-relay processing units 1a, 1b, and 1c until reception of a processing-result message in response to the processing-request message.

The processing execution device 3 comprises the processing execution units 3a, 3b, and 3c. When the processing execution units 3a, 3b, and 3c receive processing-request messages from the message relay device 1, the processing execution units 3a, 3b, and 3c execute processing in accordance with the processing-request messages, and pass to the message relay device 1 results of the execution in the form of processing-result messages.

In the above system, first, each of the message-relay processing units 1a, 1b, and 1c sends to the gateway 2a a notification that a name of a connection which is to be established is X, and establishes the connection between the message-relay processing unit and the gateway 2a. Thereafter, when a client passes a processing-request message to the gateway 2a, and the name X is designated in the processing-request message as a destination, the gateway 2a selects one of the message-relay processing units which is currently ready to process a processing-request message, and transmits the processing-request message passed from the client, by using a connection established between the selected message-relay processing unit and the gateway 2a.

When a message-relay processing unit acquires the above processing-request message, the message-relay processing unit transforms the data structure of the received processing-request message into a data structure used in the processing execution units 3a, 3b, and 3c, and passes the processing-request message having the transformed data structure to one of the processing execution units. When the processing execution unit receives the processing-request message, the processing execution unit executes processing in accordance with the processing-request message, and passes a processing-result message to the message-relay processing unit.

When the message-relay processing unit receives the processing-result message from the processing execution unit, the message-relay processing unit transforms the data structure of the received processing-result message into a data structure used in the client, and passes the processing-result message having the transformed data structure to the client.

The message-relay-processing starting unit 1j monitors the operational statuses of the message-relay processing units 1a, 1b, and 1c. When the number of processing-request messages which are concurrently being processed by the message-relay processing units 1a, 1b, and 1c exceeds the aforementioned threshold value for increase, the message-relay-processing starting unit 1j newly starts at least one message-relay processing unit. As mentioned before, the number of the at least one message-relay processing unit is predetermined.

Since at least one message-relay processing unit is newly started (i.e., the multiplicity is increased) when the number of processing-request messages is increased, it is possible to secure at least one message-relay processing unit which is currently ready to process a processing-request message, in preparation for increase in the number of concurrently processed processing-request messages. Therefore, the possibility that processing-request messages are stored in the wait queues is decreased, and increase in the clients' waiting times can be prevented. In addition, since the number of active message-relay processing units is small when the number of concurrently processed processing-request messages is small, resources such as a memory in the message relay device 1 can be efficiently used.

Hereinbelow, the differences in the startup timings of the message-relay processing units between the system according to the present invention as illustrated in FIG. 1 and the conventional techniques are explained.

The conventional message relay devices each have a single communication unit and a plurality of message-relay processing units. The communication unit opens a port at an address X, and waits for a request from a client. Each client designates the port address X for connection with a server, and performs communication with the server. In the conventional construction, each message-relay processing unit receives and passes data from and to the communication unit, and is not provided with a processing function for communication with the outside. Therefore, reception of a request triggers a start of a message-relay processing unit, and thus it is impossible to increase the multiplicity of the message-relay processing units unless a plurality of requests are simultaneously received.

In addition, in the conventional construction, the transaction conditions of the message-relay processing units are not managed. That is, no measure is provided for counting the number of concurrently processed processing-request messages. Therefore, even when excessive message-relay processing units are started in advance, it is impossible to determine whether or not there is a message-relay processing unit which is currently ready to process a processing-request message.

On the other hand, as illustrated in FIG. 1, in the system according to the present invention, each of the message-relay processing units 1a, 1b, and 1c is provided with a function for communication with the outside, and the message-relay processing units 1a, 1b, and 1c can be started together (i.e., in a multiplexed manner). In addition, since the statuses of the message-relay processing units 1a, 1b, and 1c can be recognized by using the shared areas, the message-relay-processing starting unit 1j can recognize the number of message-relay processing units which are currently processing processing-request messages. Therefore, it is possible to newly start at least one message-relay processing unit in order to increase the multiplicity when the number of message-relay processing units which are currently processing processing-request messages exceeds the aforementioned threshold value for increase. At this time, a plurality of new message-relay processing units can be started simultaneously.

Hereinbelow, details of the embodiments of the present invention are explained.

### First Embodiment

In the first embodiment, the present invention is applied to a message relay device connecting two application servers which execute transaction processing. In some cases where transactions in a company or the like are processed by a computer system, a function of transaction processing of a first application server is required to be used in transaction processing in a second application server. In such cases, a processing-request message containing the second application server's request to the first application server for transaction processing and a processing-result message containing a result of the transaction processing to be received by the second application server can be transmitted through the message relay device. In many cases where systems are linked as above, transaction processing in a system which outputs requests and receives results requires prompt response.

In addition, in many cases where a great amount of transaction processing is required to be simultaneously executed, it is required that responses in processing for individual transactions do not deteriorate. When the present invention is applied to the message relay device so that the multiplicity of message-relay processing functions is controlled, it is possible to prevent deterioration of the responses.

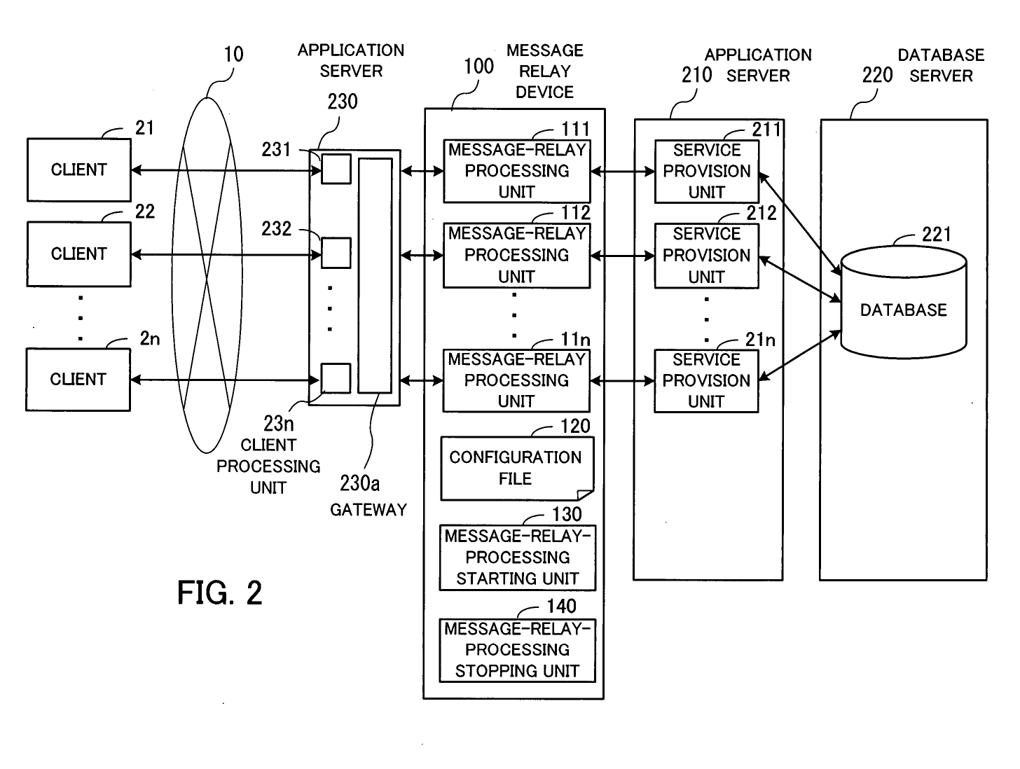

FIG. 2 is a diagram illustrating an example of a construction of the system of the first embodiment of the present invention. The system of FIG. 2 comprises a message relay device 100, the application server 210 connected to the message relay device 100, the database server 220 connected to the application server 210, and the application server 230 which is arranged between the message relay device 100 and the plurality of client computers 21, 22, . . . , 2n, where the plurality of client computers 21, 22, . . . , 2n are connected to the system through the network 10.

The message relay device 100 has functions of receiving processing-request messages from other systems and returning processing-result messages to the sources of the processing-request messages. In order to realize the above functions, the message relay device 100 comprises one or more message-relay processing units 111, 112, . . . , 11n, a configuration file 120, a message-relay-processing starting unit 130, and a message-relay-processing stopping unit 140, where the configuration file 120 is stored in advance in a storage device. The one or more message-relay processing units 111, 112, . . . , 11n, the message-relay-processing starting unit 130, and the message-relay-processing stopping unit 140 are functions realized when the message relay device 100 executes an application program. That is, each of the one or more message-relay processing units 111, 112, . . . , 11n, the message-relay-processing starting unit 130, and the message-relay-processing stopping unit 140 is a process executed in the message relay device 100. Alternatively, an arbitrary number of message-relay processing units can be created as threads in a single process in the message relay device 100.

Each of the one or more message-relay processing units 111, 112, . . . , 11n executes processing for relaying a message. More than one of the message-relay processing units 111, 112, . . . , 11n can operate concurrently, and therefore a plurality of processing-request messages can be processed in parallel. The configuration file 120 is a file in which settings for processing for relaying messages are registered. The message-relay-processing starting unit 130 monitors the operational status of the processing for relaying messages, and newly starts at least one message-relay processing unit when necessary. The message-relay-processing stopping unit 140 also monitors the operational status of the processing for relaying messages, and executes processing for stopping operation of at least one message-relay processing unit which is determined to be unnecessary.

The client computers 21, 22, . . . , 2n transmit processing-request messages to the application server 230, and receive processing-result messages from the application server 230.

The application server 210 executes transaction processing. The application server 210 comprises a plurality of service provision units 211, 212, . . . , 21n. The service provision units 211, 212, . . . , 21n are functions realized when the application server 210 executes an application program for the transaction processing, which is stored in advance in a storage device.

The database server 220 manages a database 221 which stores information necessary for transaction processing.

The application server 230 comprises a gateway 230a and client processing units 231, 232, . . . , 23n. Each of the client processing units 231, 232, . . . , 23n receives remote access by the client computers 21, 22, . . . , 2n, and executes processing functions provided in the application server 230. When processing to be performed by cooperation between the application servers 230 and 210 occurs, the client processing units 231, 232, . . . , 23n pass a processing-request message to the gateway 230a.

The gateway 230a establishes in advance connections between the gateway 230a and the one or more message-relay processing units 111, 112, . . . , 11n in the message relay device 100, and keeps track of the operational statuses of the one or more message-relay processing units 111, 112, . . . , 11n through the connections. When the gateway 230a receives a processing-request message from the client processing units 231, 232, . . . , 23n, the gateway 230a sends the processing-request message to one of the message-relay processing units which is currently ready to process a processing-request message.

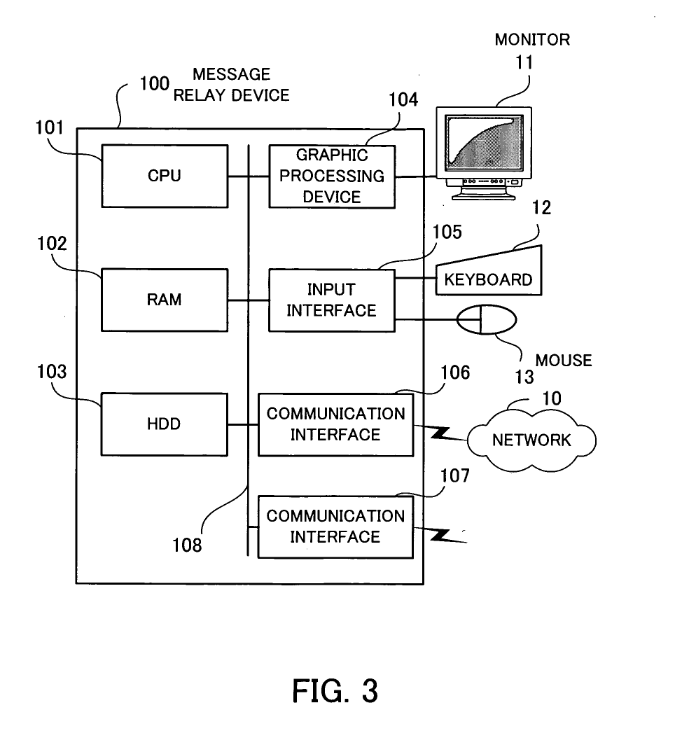

FIG. 3 is a diagram illustrating an example of a hardware construction of a message relay device used in the first embodiment. The entire system of the message relay device 100 is controlled by a CPU (central processing unit) 101, to which a RAM (random access memory) 102, an HDD (hard disk drive) 103, a graphic processing device 104, an input interface 105, and communication interfaces 106 and 107 are connected through a bus 108.

The RAM 102 temporarily stores at least a portion of an OS (operating system) program and application programs which are executed by the CPU 101, as well as various types of data which are necessary for the CPU 101 to perform processing. The HDD 103 stores the OS program and the application programs.

A monitor 11 is connected to the graphic processing device 104, which makes the monitor 11 display an image on an screen in accordance with an instruction from the CPU 101. A keyboard 12 and a mouse 13 are connected to the input interface 105, which transmits signals transmitted from the keyboard 12 and the mouse 13, to the CPU 101 through the bus 108.

The communication interface 106 is connected to the network 10. The communication interface 106 is provided for exchanging data with other computers through the network 10.

The communication interface 107 is connected to the application servers 210 and 230. The communication interface 107 is provided for exchanging data with the application servers 210 and 230.

By using the above hardware construction, it is possible to realize the processing functions the message relay device 100 in the first embodiment of the present invention. In addition, each of the client computers 21, 22, . . . , 2n, the application server 210, the database server 220, and the application server 230 can also be realized by a similar hardware construction.

In the construction illustrated in FIGS. 2 and 3, messages are transmitted between the message relay device 100 and the client computers 21, 22, . . . , 2n.

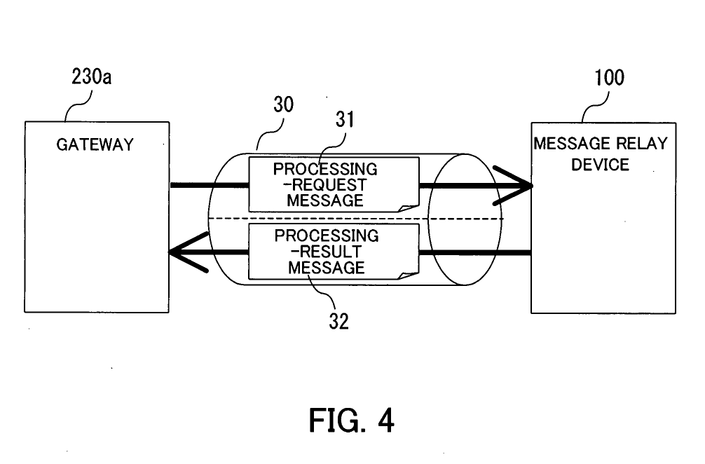

FIG. 4 is a diagram illustrating messages flowing between the gateway and the message-relay processing device. The gateway 230a establishes a connection 30 between the gateway 230a and the message relay device 100 through the network 10. The gateway 230a sends a processing-request message 31 to the message relay device 100 through the connection 30. When transaction processing is completed, the message relay device 100 sends a processing-result message 32 to the gateway 230a through the connection 30.

In the message relay device 100, the one or more message-relay processing units 111, 112, . . . , 11n execute processing of the processing-request messages 31. Only a predetermined number of message-relay processing units are initially started. Thereafter, at least one additional message-relay processing unit is started or at least one active message-relay processing unit is stopped (i.e., operation is stopped) according to operational statuses of the one or more message-relay processing units 111, 112, . . . , 11n.

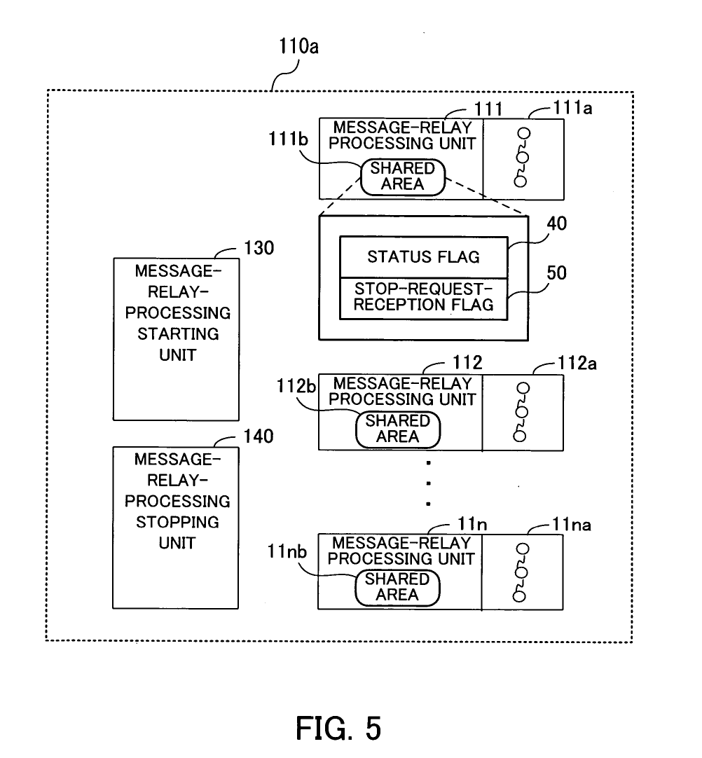

FIG. 5 is a diagram illustrating constructions of the message-relay processing units. Each of the one or more message-relay processing units 111, 112, . . . , 11n is created by the message-relay-processing starting unit 130, and the number of the message-relay processing units 111, 112, . . . , 11n is one or greater. The one or more message-relay processing units 111, 112, . . . , 11n have one or more wait queues 111a, 112a, . . . , 11na, respectively. Each of the wait queues 111a, 112a, . . . 11na is provided for storing a processing-request message newly received by the message-relay processing unit including the wait queue until processing of a processing-request message which is currently executed by the message-relay processing unit including the wait queue is completed. Although, in the example of FIG. 5, each of the one or more message-relay processing units 111, 112, . . . , 11n includes a wait queue, a portion of the one or more message-relay processing units ill, 112, . . . , 11n may not have a wait queue.

The message-relay-processing stopping unit 140 stops operation of each of the one or more message-relay processing units 111, 112, . . . , 11n according to the statuses of execution of processing of processing-request messages.

In addition, the one or more message-relay processing units 111, 112, . . . , 11n have one or more shared areas 111b, 112b, . . . , 11nb, respectively. Each of the shared areas 111b, 112b, . . . , 11nb is a storage area of a memory, and each of the one or more message-relay processing units 111, 112, . . . , 11n shares the corresponding one of the shared areas 111b, 112b, . . . 11nb with the message-relay-processing starting unit 130 and the message-relay-processing stopping unit 140.

The statuses of the one or more message-relay processing units 111, 112, . . . , 11n are indicated in the shared areas 111b, 112b, . . . , 11nb, respectively. For example, a status flag 40 and a stop-request-reception flag 50 are arranged in the shared area 111b.

The status flag 40 in the shared area 111b indicates the current operational status of the message-relay processing unit 111. The status indicates “stopped,” “ready,” or “currently processing.” In the “stopped” state, reception of a processing-request message is stopped, i.e., no connection between the message-relay processing unit and a client is established. In the “ready” state, the message-relay processing unit can receive a processing-request message. That is, when a connection between the message-relay processing unit and a client is established, the message-relay processing unit comes into the “ready” state. In the “currently processing” state, processing of a processing-request message is currently being executed.

The stop-request-reception flag 50 in the shared area 111b is a flag provided for instructing the message-relay processing unit 111 to stop its function, and set by the message-relay-processing stopping unit 140. When a value instructing the message-relay processing unit 111 to stop its function is set in the stop-request-reception flag 50 in the shared area 111b, the message-relay processing unit 111 stops its function.

By monitoring the statuses set in the one or more shared areas 111b, 112b, . . . , 11nb, the message-relay-processing starting unit 130 and the message-relay-processing stopping unit 140 can recognize the number of messages which are actually processed in parallel by the one or more message-relay processing units 111, 112, . . . , 11n.

Further, the message relay device 100 may comprise a plurality of processing units 110a each having the construction illustrated in FIG. 5.

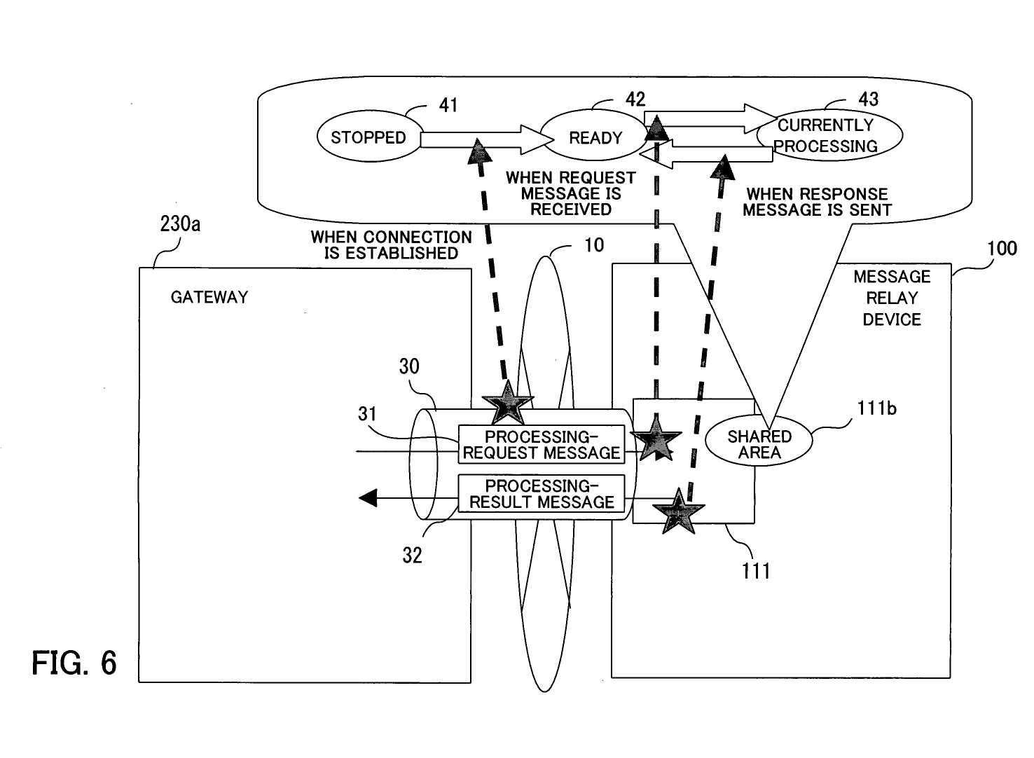

FIG. 6 is a diagram illustrating state transitions in a message-relay processing unit. First, when the connection 30 is established between the gateway 230a and the message-relay processing unit 111, a value 41 indicating the “stopped” state is set in the status flag 40. Next, when the gateway 230a sends a processing-request message 31 to the message-relay processing unit 111, the value of the status flag 40 in the shared area 111b is changed to a value 42 indicating the “ready” state. While the message-relay processing unit 111 is executing processing, the value of the status flag 40 in the shared area 111b is a value 43 indicating the “currently processing” state. Thereafter, when the message-relay processing unit 111 sends a processing-result message 32 to the gateway 230a, the value of the status flag 40 in the shared area 111b is changed to the value 42 indicating the “ready” state.

The message-relay processing unit 111 changes the setting of the status flag 40 in the shared area 111b. Although FIGS. 5 and 6 show details of only the shared area 111b of the message-relay processing unit 111, the shared areas 112b, . . . , llnb in the other message-relay processing units 112, . . . , 11n each have a similar construction to the shared area 111b of the message-relay processing unit 111. The flags in each shared area can be updated by only the message-relay processing unit which includes the shared area.

Next, sequences of processing for updating and referring to the values of the shared area 111b in the message-relay processing unit 111 are explained below. After the message-relay processing unit 111 establishes a connection between the gateway 230a and the message-relay processing unit 111, the message-relay processing unit 111 continues execution of a function of waiting for reception (wait-for-reception function) by continuing execution of loop processing.

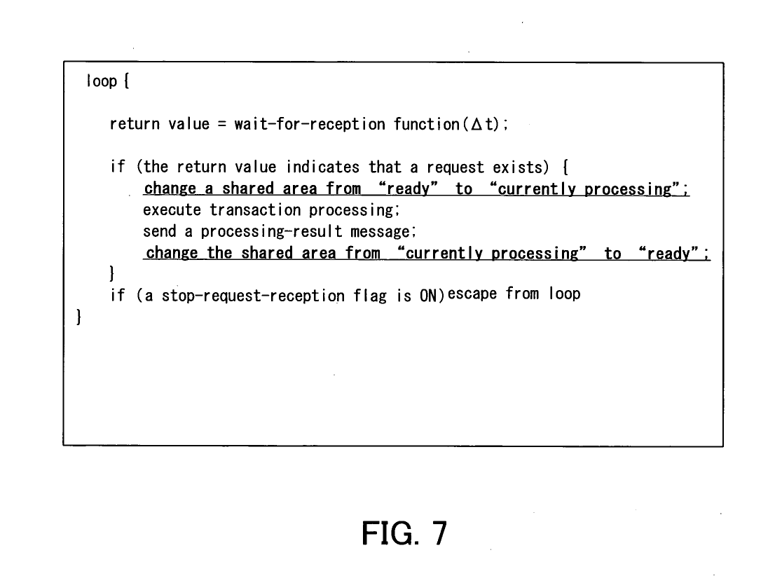

FIG. 7 is a diagram illustrating loop processing for updating and referring to a shared area. The return value of the wait-for-reception function indicates whether or not a request exists, except when an error occurs. Specifically, when the message-relay processing unit 111 has not received a processing-request message for a duration Δt, the return value of the wait-for-reception function indicates that no request exists. When execution of the wait-for-reception function is started at time T1, and a processing-request message is received at time T2 (where T2−T1<Δt), the return value of the wait-for-reception function indicates that a request exists.

That is, when a processing-request message is received, the wait-for-reception function generates a “request” event (reception event). When the return value of the wait-for-reception function indicates that a request exists, i.e., when a notification of a reception event is made, the message-relay processing unit 111 changes the status flag 40 in the shared area 111b to “currently processing,” and executes transaction processing. When the transaction processing is completed, the message-relay processing unit 111 sends a processing-result message to the gateway 230a, and returns the status flag 40 in the shared area 111b to the “ready” state.

The absolutely necessary condition which is imposed on the message-relay processing unit 111 is that processing of each processing-request message which is currently being executed by the message-relay processing unit 111 is not allowed to be stopped before the processing is completed. Therefore, while the shared area lllb is used for monitoring the transaction status according to the present invention, the shared area 111b is also used for storing the stop-request-reception flag 50, which is originally provided for safely stopping the processing performed by the message-relay processing unit 111.

In order to stop the message-relay processing unit 111, the message-relay-processing stopping unit 140 sets the stop-request-reception flag 50 in the shared area 111b to ON. Then, the operation of the message-relay processing unit 111 returns to the wait-for-reception function, and executes transaction processing when the message-relay processing unit 111 receives a processing-request message. Thereafter, the operation of the message-relay processing unit 111 escapes from the loop since the stop-request-reception flag 50 in the shared area 111b is ON. Even when the message-relay processing unit 111 receives no processing-request message after the return to the wait-for-reception function, the message-relay processing unit 111 escapes from the loop without doing anything. Thus, when the stop-request-reception flag 50 is used, the message-relay processing unit 111 can safely, not forcedly, stop its operation.

Since the area for monitoring the transaction status is added to the shared area 111b, and the two steps related to the indication of the “currently processing” state (underlined in FIG. 7) are added, the message-relay-processing starting unit 131 can calculate the number of message-relay processing units which are currently processing processing-request messages and the number of message-relay processing units which are currently ready to process a processing-request message, and recognize the number of processing-request messages which are concurrently being processed.

Further, the one or more message-relay processing units 111, 112, . . . , 11n execute processing in the operational environment defined in the configuration file 120.

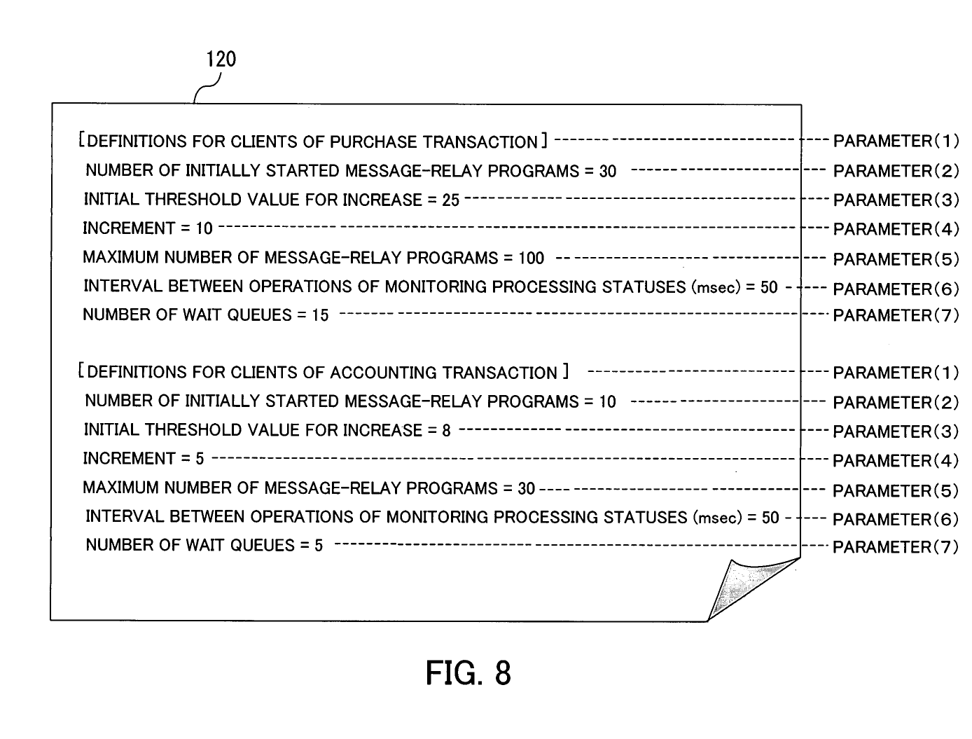

FIG. 8 is a diagram illustrating an example of a data structure of the configuration file. In the configuration file 120, environmental variables for each type of transaction processing are defined. The environmental variables are constituted by the following seven parameters (1) to (7).

The parameter (1) indicates a name for identifying a client transaction. Since the contents of the processing-request message 31, the processing-result message 32, and the frequency of occurrence of messages are different for each client transaction, each client transaction must be identified.

The parameter (2) indicates the number of message-relay processing units which are initially started (i.e., the number of message-relay processing units started at the time of startup of the message relay device 100).

The parameter (3) indicates an initial threshold value for increase. The initial threshold value for increase is a threshold value of the number of message-relay processing units which are concurrently processing processing-request messages, and is an initial value of a criterion for judging whether or not the number of active message-relay processing units is to be increased. When the number of message-relay processing units which are concurrently processing processing-request messages first exceeds the initial threshold value for increase, at least one new message-relay processing unit is created.

The parameter (4) indicates a value of the increment. The increment is the number of message-relay processing units which are newly created in order to increase the number of active message-relay processing units. For example, the number of at least one message-relay processing unit which is newly created when the number of message-relay processing units which are concurrently processing processing-request messages first exceeds the initial threshold value for increase is equal to the value of the increment.

A plurality of additional threshold values for increase are each defined as a sum of the initial threshold value for increase and n times the value of the increment, where n is a non-negative integer. The initial value of the variable n is zero. The variable n is incremented by one every time at least one message-relay processing unit the number of which is equal to a value of the increment is newly started, and decremented by one every time at least one of active message-relay processing units the number of which is equal to a value of the increment is newly stopped. That is, at least one message-relay processing unit the number of which is equal to the value of the increment indicated as the parameter (4) is newly created when the number of message-relay processing units which are concurrently processing processing-request messages exceeds a threshold value for increase.

In addition, a plurality of threshold values for decrease are each defined as a sum of the initial threshold value for increase and (n-1) times the value of the increment. That is, at least one message-relay processing unit the number of which is equal to the value of the increment indicated as the parameter (4) is newly stopped when the number of message-relay processing units which are concurrently processing processing-request messages becomes equal to or smaller than a threshold value for decrease.

The parameter (5) indicates the maximum number of started (active) message-relay processing units.

The parameter (6) indicates the interval between operations of monitoring the processing statuses of the one or more message-relay processing units 111, 112, . . . , 11n. For example, the interval is indicated in milliseconds.

The parameter (7) indicates the number of wait queues which are included in the one or more message-relay processing units 111, 112, . . . , 11n (i.e., the number of holding queues).

Hereinbelow, details of processing executed in the system according to the first embodiment are explained below.

On startup of the system, the message relay device 100 starts the message-relay-processing starting unit 130.

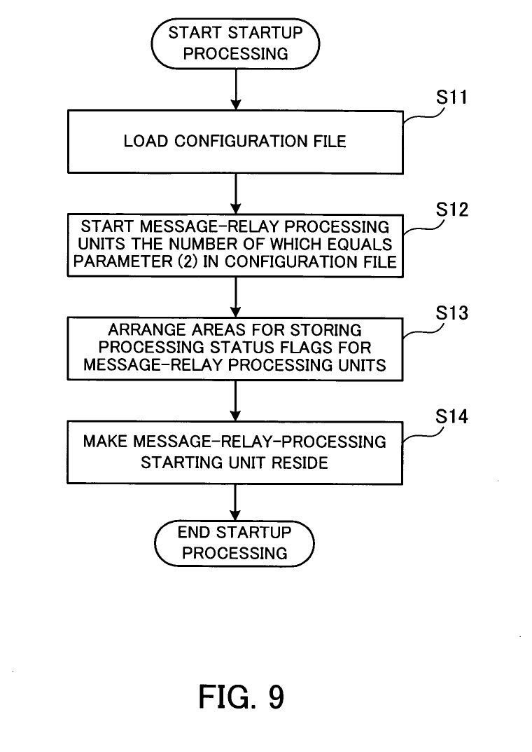

FIG. 9 is a flow diagram illustrating processing performed when the message-relay-processing starting unit is started. The processing illustrated in FIG. 9 is explained below step by step.

[Step S11] When the message-relay-processing starting unit 130 is started, the message-relay-processing starting unit 130 loads the configuration file 120. Thereafter, when the parameter (1) in the configuration file 120 is designated by a user's manipulation input or the like, the message-relay-processing starting unit 130 loads information on the parameters (2) to (6) belonging to the transaction corresponding to the designated parameter (1).

[Step S12] The message-relay-processing starting unit 130 starts one or more message-relay processing units 111, 112, . . . , 11n designated by the parameter (2), where the number of the one or more message-relay processing units 111, 112, . . . , 11n is the number designated by the parameter (2).

[Step S13] When the message-relay-processing starting unit 130 starts the one or more message-relay processing units 111, 112, . . . , 11n, the message-relay-processing starting unit 130 arranges one or more areas for storing one or more processing status flags which enable the message-relay-processing starting unit 130 to determine whether or not the one or more message-relay processing units 111, 112, . . . , 11n are processing one or more processing-request messages, respectively. The one or more areas for storing one or more processing status flags are exclusively used by the message-relay processing program, and can be referred to by the message-relay-processing starting unit 130.

[Step S14] In order to monitor the processing statuses of the one or more message-relay processing units 111, 112, . . . , 11n, the message-relay-processing starting unit 130 resides in a memory space as a process of the message relay device 100 after the operation of starting the one or more message-relay processing units 111, 112, . . . , 11n is completed. That is, the message-relay-processing starting unit 130 resides in a storage area in the message relay device 100. Then, at the time intervals corresponding to the interval indicated by the parameter (6) of the configuration file 120, the message-relay-processing starting unit 130 refers to all of the shared areas belonging to the one or more message-relay processing units 111, 112, . . . , 11n started by the message-relay-processing starting unit 130, and recognizes the number of processing-request messages which are being processed in parallel.

In addition, at the same time as the startup of the message-relay-processing starting unit 130, the message-relay-processing stopping unit 140 is also started, and also resides in the memory space as a process of the message relay device 100.

After the startup of the message relay device 100, when manipulation inputs into the application server 230 from the client computers 21, 22, . . . , 2n are made, and processing-request messages to be sent to the application server 210 are outputted, the gateway 230a assigns the processing-request messages to the one or more message-relay processing units 111, 112, . . . , 11n.

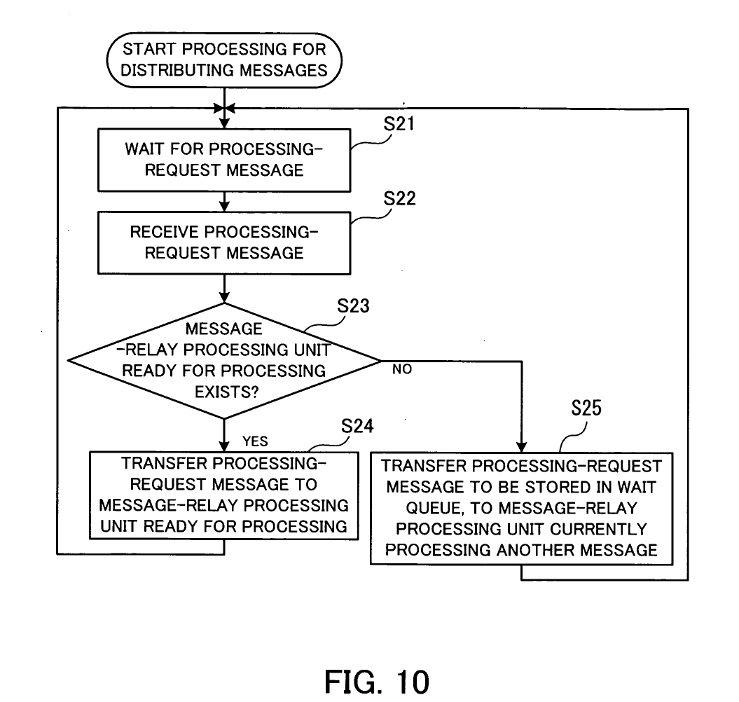

FIG. 10 is a flow diagram illustrating a processing sequence of the gateway when the gateway receives a processing-request message. The processing illustrated in FIG. 10 is explained below step by step.

[Step S21] The gateway 230a waits for a processing-request message which is outputted from the client processing units 231, 232, . . . , 23n based on an instruction from the client computers 21, 22, . . . , 2n.

[Step S22] The gateway 230a receives a processing-request message outputted from the client processing units 231, 232, . . . , 23n.

[Step S23] The gateway 230a determines whether or not a message-relay processing unit is ready to process the processing-request message. Specifically, the gateway 230a refers to the status flags in the shared areas 111b, 112b, . . . , llnb of the one or more message-relay processing units 111, 112, . . . , 11n, and determines that a message-relay processing unit is ready to process the processing-request message when one of the status flags of the one or more message-relay processing units 111, 112, . . . , 11n is in the “ready” state. When yes is determined in step S23, the operation goes to step S24. When no is determined in step S23, the operation goes to step S25.

[Step S24] The gateway 230a passes the processing-request message received in step S22 to the message-relay processing unit which is ready to process the processing-request message. Thereafter, the operation goes to step S21.

[Step S25] The gateway 230a passes the processing-request message received in step S22 to one of the one or more message-relay processing units 111, 112, . . . , 11n which are currently processing a processing-request message. At this time, the processing-request message sent from the gateway 230a is stored in the wait queue. Thereafter, the operation goes to step S21.

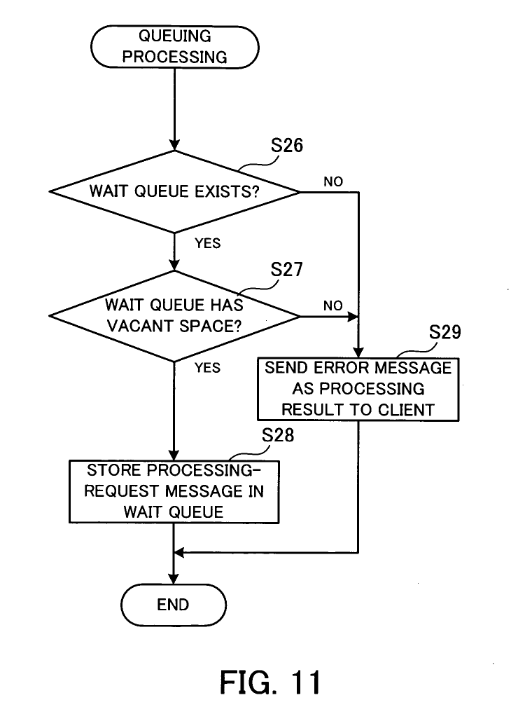

FIG. 11 is a flow diagram illustrating a sequence of processing performed by a message-relay processing unit when the message-relay processing unit receives the processing-request message which is to be stored in a wait queue. The processing illustrated in FIG. 11 is explained below step by step, where it is assumed that the message-relay processing unit 111 receives the processing-request message.

[Step S26] The message-relay processing unit 111 determines whether or not the message-relay processing unit 111 has a wait queue. When yes is determined, the operation goes to step S27. When no is determined, the operation goes to step S29.

[Step S27] The message-relay processing unit 111 determines whether or not the wait queue has vacant space. When yes is determined, the operation goes to step S28. When no is determined, the operation goes to step S29.

[Step S28] The message-relay processing unit 111 stores the received processing-request message in the wait queue which has vacant space.

[Step S29] The message-relay processing unit 111 sends a processing-result message to the gateway 230a, where the processing-result message indicates that the result of processing of the received processing-request message is an error.

As illustrated in FIGS. 10 and 11, in the case where a message-relay processing unit is ready to process a processing-request message when the processing-request message is received from a client, the received processing-request message is passed to the message-relay processing unit. On the other hand, in the case where no message-relay processing unit is ready to process a processing-request message when the processing-request message is received from a client, the received processing-request message is stored in a wait queue.

In addition, in the case where no message-relay processing unit is ready to process a processing-request message and no message-relay processing unit has a wait queue when a processing-request message is received from a client, the client is notified that the result of processing is an error. Further, in the case where no wait queue has vacant space even when at least one message-relay processing unit has a wait queue, the client is also notified that the result of processing is an error. In the case where a wait queue has vacant space, the received processing-request message is stored in the wait queue.

On the other hand, when a message-relay processing unit which has been started receives a processing-request message, the message-relay processing unit executes processing of the processing-request message.

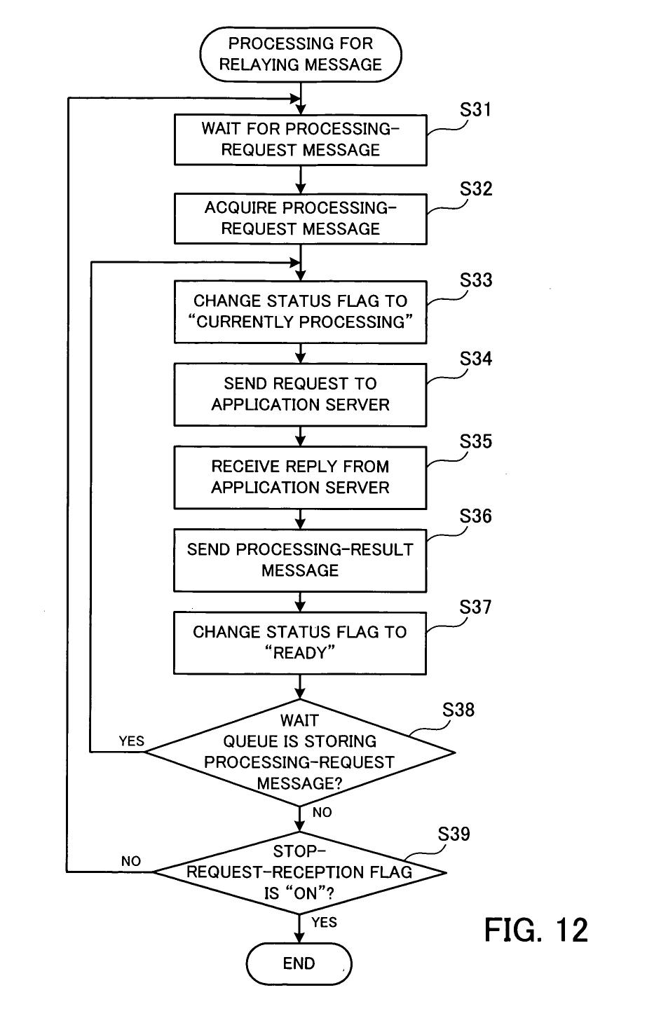

FIG. 12 is a flow diagram illustrating a sequence of processing performed by a message-relay processing unit. In the following explanations, it is assumed that the processing illustrated in FIG. 12 is executed by the message-relay processing unit 111, and FIG. 5 is also referred to as well as FIG. 12.

[Step S31] The message-relay processing unit 111 waits for input of a processing-request message.

[Step S32] The message-relay processing unit 111 acquires a processing-request message from the gateway 230a.

[Step S33] The message-relay processing unit 111 changes the status flag 40 in the shared area 111b from “ready” to “currently processing.”

[Step S34] The message-relay processing unit 111 sends to the application server 210 a request corresponding to the processing-request message. That is, the message-relay processing unit 111 transforms the processing-request message so that the transformed request has a data structure which can be recognized by the application server 210, and sends the transformed request to the application server 210.

[Step S35] The message-relay processing unit 111 receives a reply from the application server 210.

[Step S36] The message-relay processing unit 111 sends to the gateway 230a a processing-result message to be sent to a client. That is, the message-relay processing unit 111 transforms a processing result indicated in the reply from the application server 210 into a processing-result message having a data structure which can be recognized by the application server 230, and sends the processing-result message to the application server 230.

[Step S37] The message-relay processing unit 111 changes the status flag 40 in the shared area 111b from “currently processing” to “ready.”

[Step S38] The message-relay processing unit 111 determines whether or not the wait queue 111a contains a processing-request message. When yes is determined, the operation goes to step S33, and processing of a processing-request message which is stored at the top of the wait queue 111a is executed. When no is determined in step S38, the operation goes to step S39.

[Step S39] The message-relay processing unit 111 determines whether or not the stop-request-reception flag 50 in the shared area 111b is ON. When the stop-request-reception flag 50 is OFF, the operation goes to step S31, and the message-relay processing unit 111 returns to a state in which the message-relay processing unit 111 waits for input of a processing-request message. When the stop-request-reception flag 50 is ON, the processing executed by the message-relay processing unit 111 is completed. When the processing executed by the message-relay processing unit 111 is completed, a thread which executes the message-relay processing unit 111 is removed from the message relay device 100.

As explained above, when the message-relay processing unit 111 is started, the message-relay processing unit 111 executes processing of acquired processing-request messages in succession. In addition, when a first processing-request message is stored in a wait queue during execution of processing of a second processing-request message, processing of the first processing-request message is executed after the execution of processing of the second processing-request message is completed. Thereafter, when the stop-request-reception flag 50 becomes ON, it is confirmed that no processing-request message is currently processed, and the wait queue contains no processing-request message. Then, the operation of the message-relay processing unit 111 is stopped.

In addition, when the number of processing-request messages inputted into the message relay device 100 increases, the number of message-relay processing units which stand ready for a processing-request message decreases. At this time, the message-relay-processing starting unit 130 monitors the statuses of the message-relay processing units, and newly starts at least one message-relay processing unit before all of the already active message-relay processing units come to execute processing of a processing-request message.

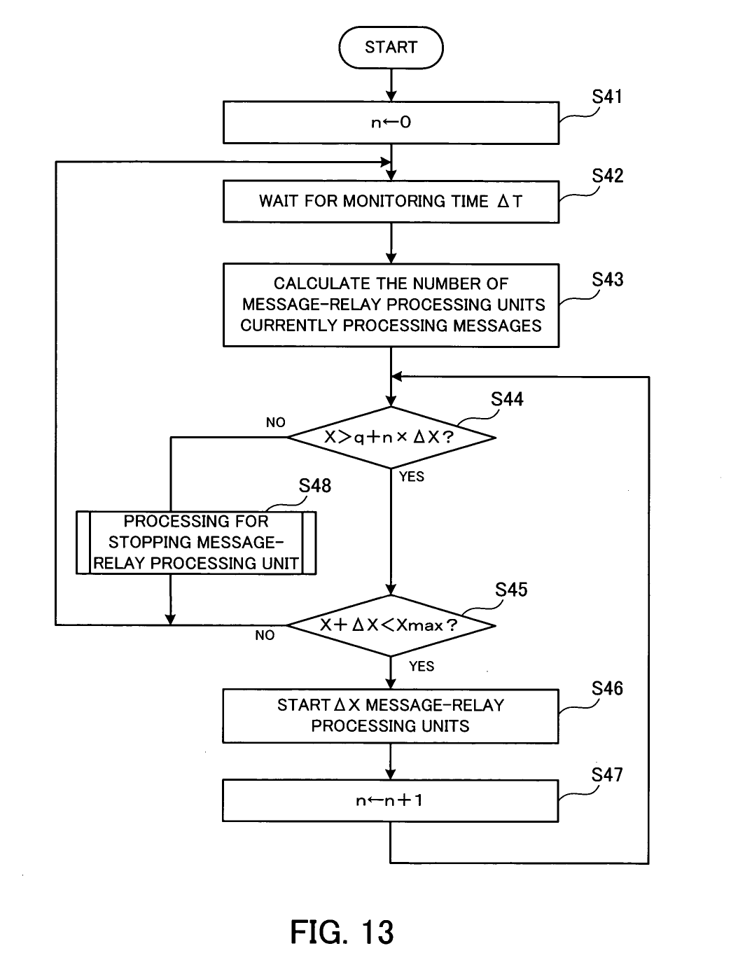

FIG. 13 is a flow diagram illustrating a sequence of processing performed by the message-relay-processing starting unit for monitoring the processing statuses of the one or more message-relay processing units. The processing illustrated in FIG. 13 is explained below step by step. In FIG. 13, ΔT is the interval between operations of monitoring the processing statuses of the one or more message-relay processing units (i.e., the parameter (6) illustrated in FIG. 8), ΔX is the increment (the parameter (4) illustrated in FIG. 8), q is the initial threshold value for increase (i.e., the parameter (3) illustrated in FIG. 8), and Xmax is the maximum number of started (active) message-relay processing units (i.e., the parameter (5) illustrated in FIG. 8).

[Step S41] The message-relay-processing starting unit 130 sets the variable n to zero, where n is generally a non-negative integer.

[Step S42] The message-relay-processing starting unit 130 waits for ΔT.

[Step S43] The message-relay-processing starting unit 130 refers to the status flag in the shared area in each message-relay processing unit which the message-relay-processing starting unit 130 has started, and calculates the number of message-relay processing units which are currently processing processing-request messages.

[Step S44] When the number of message-relay processing units which are currently processing processing-request messages is indicated by X, the message-relay-processing starting unit 130 determines whether or not the value of X is greater than a sum of the initial threshold value for increase q and n times the increment (X>q+nXΔX). When yes is determined, the operation goes to step S45. When no is determined, the operation goes to step S48.

[Step S45] The message-relay-processing starting unit 130 determines whether or not a sum of the value X and the increment ΔX is smaller than the maximum number Xmax of the started message-relay processing units (X+ΔX<Xmax). When yes is determined, the operation goes to step S46. When no is determined, the operation goes to step S42.

[Step S46] In the case where X+ΔX<Xmax, the message-relay-processing starting unit 130 newly starts at least one message-relay processing unit, where the number of the at least one message-relay processing unit which is newly started is equal to the increment ΔX.

[Step S47] The message-relay-processing starting unit 130 increments the variable n by one. Thereafter, the operation goes to step S44.

[Step S48] The message-relay-processing stopping unit 140 executes processing for stopping at least one of already created message-relay processing units, where the number of the at least one stopped message-relay processing unit is equal to a predetermined number. Thereafter, the operation goes to step S42.

As explained above, according to the first embodiment, an upper limit of the number of message-relay processing units which execute processing is provided. That is, in step S45, processing is performed for preventing increase in the number of active message-relay processing programs with increase in the number of processing-request messages from clients. Therefore, it is possible to prevent exhaustion of the storage device such as the RAM 102 in the message relay device 100 which may be caused by unlimited increase in the number of active message-relay processing units.

Further, since the variable n is incremented in consideration of the increase in the number of the processes in step S46, the threshold value “q+nX” increases by ΔX. After the increment in the variable n, the operation goes to step S44, and the number of message-relay processing units which are currently processing processing-request messages is compared with a threshold value again. Thus, it is possible to newly start message-relay processing units even when the value X rapidly increases so that the number of the newly started message-relay processing units corresponds to the increase rate of the value X.

Furthermore, when no is determined in step S44, it is necessary to execute the processing for decreasing the number of already created message-relay processing units (in step S48). If this processing for decreasing the number of already created message-relay processing units is not executed, excessive message-relay processing units due to the increase in step S46 will uselessly occupy the storage device in the message relay device 100 when the number of processing requests from the clients decreases.

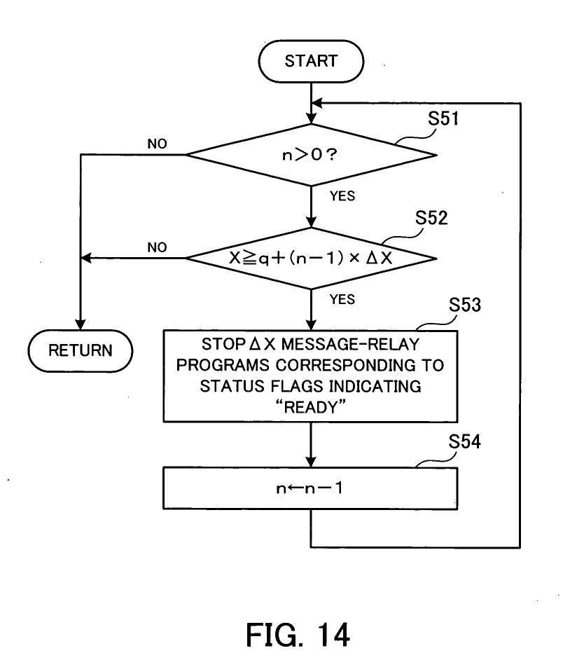

FIG. 14 is a flow diagram illustrating a sequence of processing for stopping the operation of at least one message-relay processing unit. The processing illustrated in FIG. 14 is explained below step by step.

[Step S51] The message-relay-processing stopping unit 140 determines whether or not the variable n is greater than zero. When the variable n is equal to zero, no message-relay processing unit exists. Therefore, the processing of FIG. 14 is completed, and the operation goes back to step S42 in FIG. 13. When the variable n is greater than zero, the operation goes to step S52.

[Step S52] The message-relay-processing stopping unit 140 determines whether or not X≧+(n−1)XΔX. When yes is determined, the operation goes to step S53. When no is determined, the processing of FIG. 14 is completed, and the operation goes back to step S42 in FIG. 13.

[Step S53] The message-relay-processing stopping unit 140 selects at least one message-relay processing unit having the status flag of “ready,” where the number of the at least one selected message-relay processing unit is equal to ΔX. Then, the message-relay-processing stopping unit 140 sets the stop-request-reception flag of each of the at least one selected message-relay processing unit to ON. Thus, the ΔX message-relay processing unit or units stop.

[Step S54] The message-relay-processing stopping unit 140 decrements the variable n by one. Thereafter, the operation goes to step S51, and the determination in steps S51 and S52 is made again. Thus, the processing for stopping the operation of the message-relay processing unit is repeated until either of the conditions n=0 and X<q+(n−1)XΔX is satisfied.

According to the above processing, when the number of message-relay processing units which are currently executing processing decreases, the number of active message-relay processing units is decreased accordingly. Thus, it is possible to prevent useless occupation of resources such as the RAM.

As explained above, when the message-relay processing method according to the present invention which can automatically increase or decrease the multiplicity of processing is used, it is possible to decrease the possibility that no message-relay processing unit is ready to process a processing-request message in the message relay device 100, which receives requests and returns responses. Therefore, errors which impede continuation of processing and storage of processing-request messages in wait queues which causes deterioration in response performance are less likely to occur. Thus, the present invention improves reliability and performance.

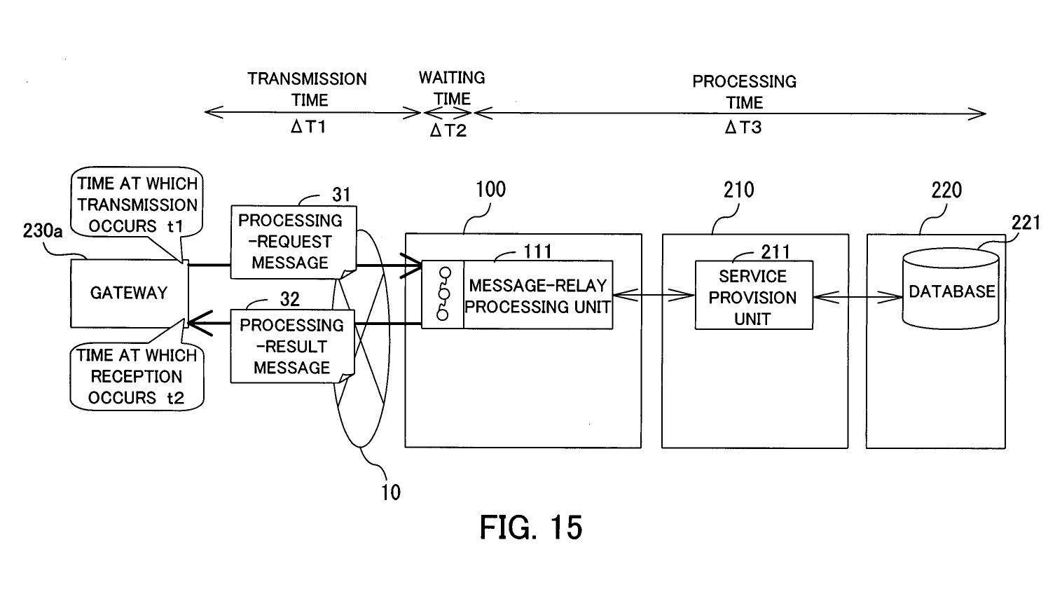

FIG. 15 is a diagram illustrating performance deterioration caused by a waiting time in a wait queue. In FIG. 15, it is assumed that the gateway 230a transmits the processing-request message 31 at time t1, and receives the processing-result message 32 at time t2.

The throughput time ΔT (=t2−t1) in the gateway 230a is a sum of the time ΔT1 (transmission time) for the processing-request message 31 to pass through the network 10, the waiting time ΔT2 in a wait queue used by the message relay program, and the time ΔT3 (processing time) necessary for processing in the message-relay processing unit 111 and a server provision unit 211 in the application server 210 and database processing in the database server 220. When the functions in the first embodiment are used, opportunities for the waiting time in the wait queue to occur can be reduced. Therefore, the throughput time can be reduced by at most ΔT2.

In addition, since it is unnecessary to maintain the performance by continuously operating the message-relay processing units in the message relay device 100 with the multiplicity corresponding to the maximum number of connections, it is possible to efficiently use the storage device in the message relay device 100. Hereinbelow, the amounts of memory used in the case where the message-relay processing units are multiplexed with the multiplicity corresponding to the maximum number of connections and in the case where the message-relay processing units are multiplexed according to the first embodiment of the present invention are compared.

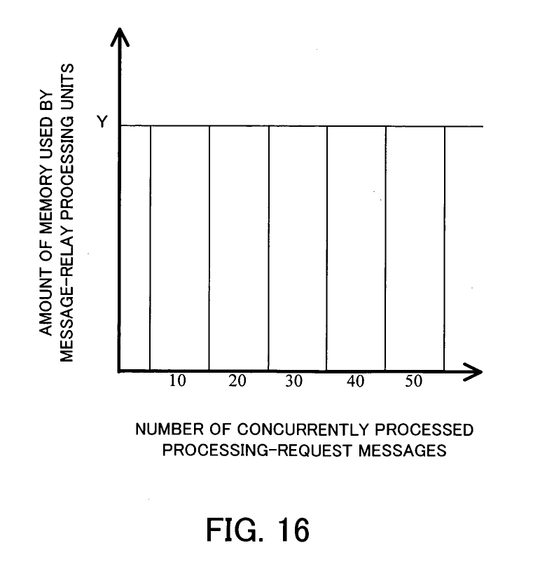

FIG. 16 is a diagram illustrating the amount of memory used in the case where message-relay processing units are multiplexed with the multiplicity corresponding to the maximum number of connections at all times. In FIG. 16, the abscissa indicates the number of processing-request messages which are concurrently processed, and the ordinate indicates the total volume of storage areas (amount of memory) used by the message-relay processing units.

In this example, the message-relay processing units are multiplexed so that at most fifty processing-request messages which are concurrently transmitted from the gateway 230a can be concurrently processed without being stored in a wait queue. That is, fifty processes for message relay processing are always active, and each of the processes uses a storage area. In FIG. 16, Y indicates the total volume of storage areas which are necessary in the case where fifty message-relay processing units are multiply operated. That is, even when the number of processing-request messages concurrently sent from the gateway 230a is smaller than fifty, the total volume of used storage areas is always equal to Y.

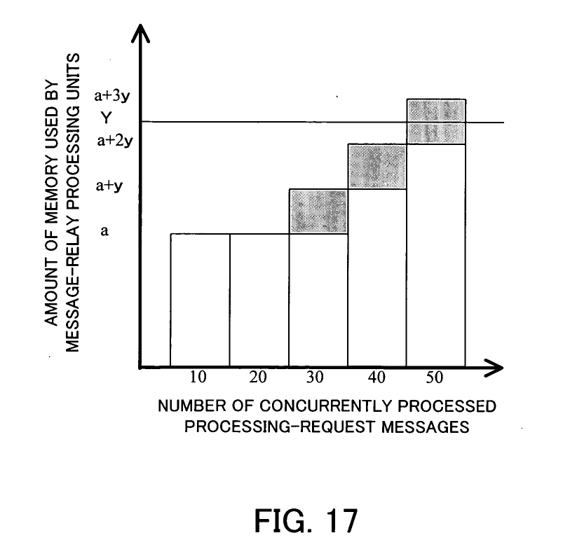

FIG. 17 is a diagram illustrating the amount of memory used in the case where message-relay processing units are multiplexed according to the first embodiment. In FIG. 17, the abscissa indicates the number of processing-request messages which are concurrently processed, and the ordinate indicates the total volume of storage areas (amount of memory) used by the message-relay processing units.

In the example of FIG. 17, as in the example of FIG. 16, the message-relay processing units are multiplexed so that at most fifty processing-request messages which are concurrently transmitted from the gateway 230a can be concurrently processed without being stored in a wait queue. In FIG. 17, it is assumed that the number of message-relay processing units which are initially started is thirty, the initial threshold value for increase is twenty-five, and the increment is ten in the configuration file 120 indicated in FIG. 8. In this case, the storage areas used by the message-relay processing units in the message relay device 100 increase or decrease according to the number of processing-request messages which are concurrently outputted from the gateway 230a.

In FIG. 17, a indicates an amount of memory which is necessary for initially starting thirty message-relay programs, and y indicates an amount of memory which is necessary for newly starting ten message-relay programs. As illustrated in FIG. 17, the amount of memory which is used when the number of concurrently processed processing-request messages does not exceed twenty-five is equal to a, the amount of memory which is used when the number of concurrently processed processing-request messages exceeds twenty-five and does not exceed thirty-five is equal to a+y, the amount of memory which is used when the number of concurrently processed processing-request messages exceeds thirty-five and does not exceed forty-five is equal to a+2y, and the amount of memory which is used when the number of concurrently processed processing-request messages exceeds forty-five is equal to a+3y.

When the volumes indicated in FIGS. 16 and 17 are compared, it is understood that the amount of memory used in the message relay device according to the first embodiment of the present invention is smaller than the amount of memory used in the message relay device to which the present invention is not applied, until the number of concurrently processed processing-request messages reaches forty.

As explained above, according to the first embodiment, a system is mounted in which the number of message-relay processing units which can receive processing-request messages is automatically increased by increasing the multiplicity when the number of received processing-request messages exceeds a threshold value for increase. Thereby, even when the number of received processing-request messages exceeds a multiplicity which is preset in the message relay device, it is possible to process the processing-request messages without occurrence of an error which impedes reception of a processing-request message.

In addition, according to the first embodiment of the present invention, even when the message-relay processing units have a wait queue, the message-relay processing units can process processing-request messages without storing the processing-request messages in the wait queue. Therefore, the processing performance does not deteriorate.

Further, according to the first embodiment, when the number of processing-request messages becomes equal to or smaller than the threshold value for decrease, the multiplicity in the message relay device 100 is recovered to the original value. Thereby, in the message relay device according to the first embodiment, the multiplicity is increased when the number of processing-request messages reaches a maximum, and a normal multiplicity is used when the number of processing-request messages does not reach the maximum. Thus, it is possible to efficiently use the storage device in the message relay device 100.

Furthermore, according to the first embodiment, it is possible to collectively start or stop more than one message-relay processing unit the number of which is equal to the increment ΔX. Therefore, it is possible to suppress the frequency of occurrence of operations of starting and stopping the message-relay processing units, and increase the processing efficiency.

### Second Embodiment

Although, according to the first embodiment, the processing-request messages are generated in the application server 230 and sent to the message relay device, alternatively, it is possible to execute at least one process realizing the functions of clients (i.e., the aforementioned client processing units) within the message relay device.

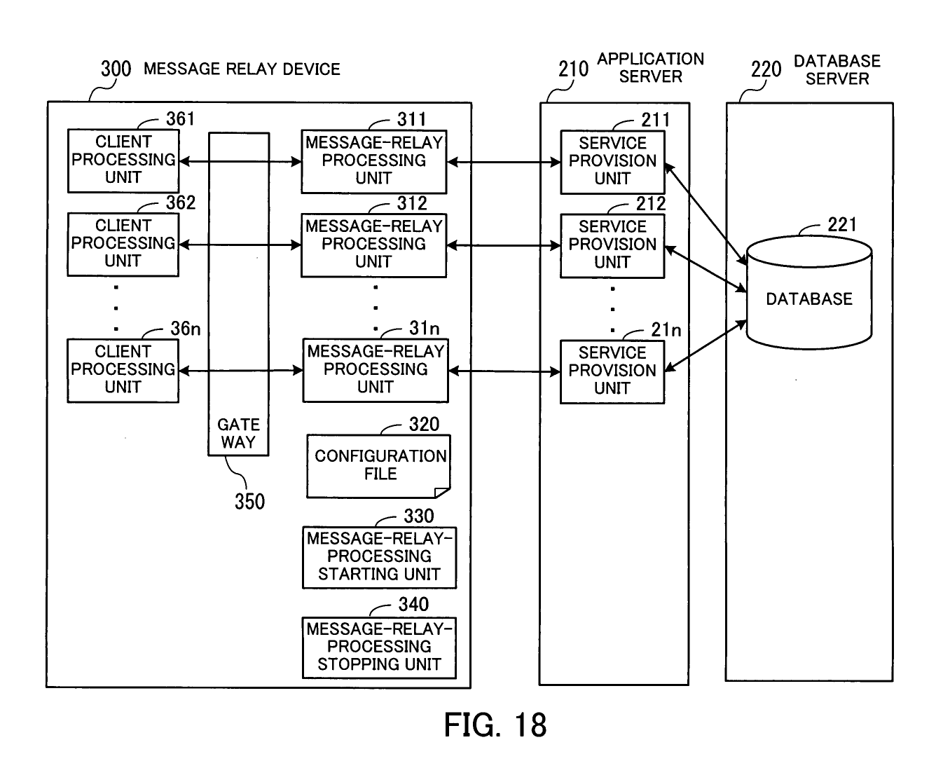

FIG. 18 is a diagram illustrating an example of a construction of a system of the second embodiment of the present invention. According to the second embodiment, client processing units 361, 362, . . . , 36n, which execute the functions of clients (i.e., the functions of inputting and outputting information according to remote access from other devices), are arranged in a message relay device 300. As the message relay device 100 in the first embodiment, the message relay device 300 comprises one or more message-relay processing units 311, 312, . . . , 31n, a configuration file 320, a message-relay-processing starting unit 330, and a message-relay-processing stopping unit 340. In addition, a gateway 350 is arranged in the message relay device 300. Each of the message-relay processing units 311, 312, . . . , 31n, the configuration file 320, the message-relay-processing starting unit 330, the message-relay-processing stopping unit 340, and the gateway 350 has a function which is identical to the element in the first embodiment (illustrated in FIG. 2) having the same name. Since the client processing units 361, 362, . . . , 36n are contained in the message relay device 300, the message relay device 300 can also have functions of a terminal control device.

### Third Embodiment

The third embodiment of the present invention is a concrete example of a system to which transaction processing is linked. Hereinbelow, the construction of the third embodiment is explained by using an example in which the present invention is applied to a system for supporting purchase transactions.

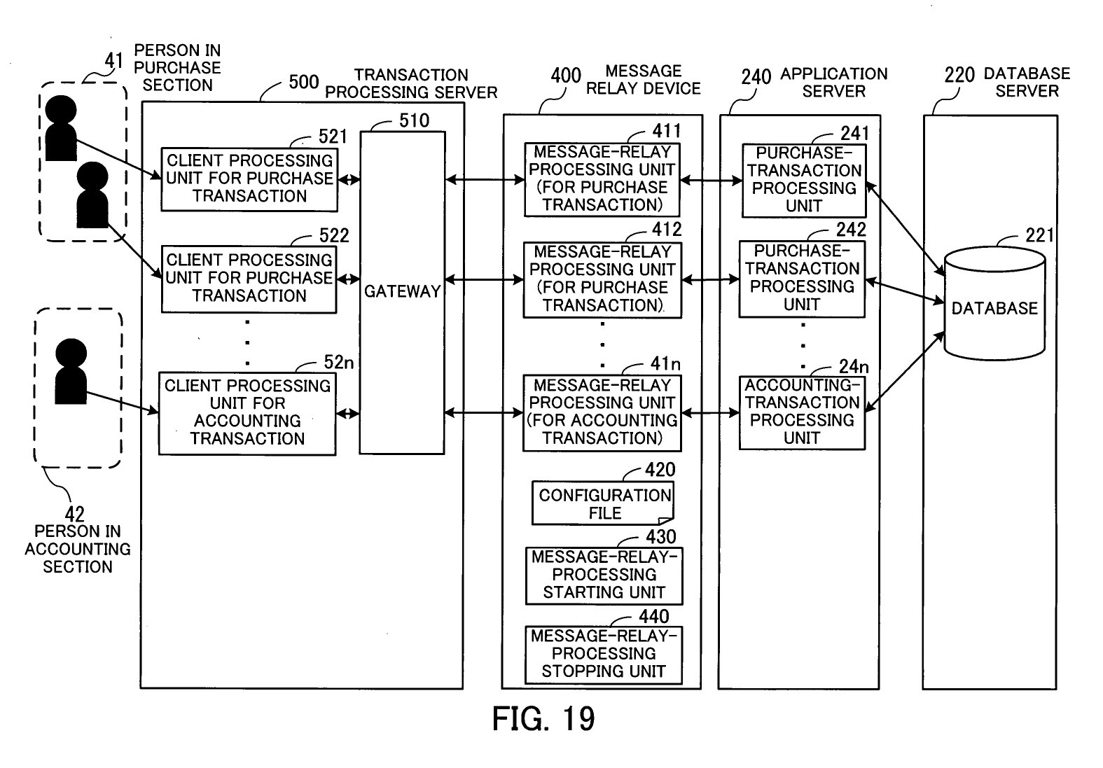

FIG. 19 is a diagram illustrating an example of a construction of a system of the third embodiment of the present invention. As illustrated in FIG. 19, a message relay device 400 is connected to a transaction processing server 500. The message relay device 400 comprises one or more message-relay processing units 411, 412, . . . , 41n, a configuration file 420, a message-relay-processing starting unit 430, and a message-relay-processing stopping unit 440. Each of the message-relay processing units 411, 412, . . . , 41n, the configuration file 420, the message-relay-processing starting unit 430, and the message-relay-processing stopping unit 440 has a function which is identical to the element in the first embodiment (illustrated in FIG. 2) having the same name. However, according to the third embodiment, the uses of the respective message-relay processing units 411, 412, . . . 41n are predetermined. Specifically, in the example of FIG. 19, the message-relay processing units 411 and 412 are used for purchase transactions, and the message-relay processing unit 41n is used for accounting transactions.

In addition, the application server 240 comprises purchase-transaction processing units 241 and 242 and an accounting-transaction processing unit 24n, and supports purchase transactions and accounting transactions by using the database 221 in the database server 220.

The transaction processing server 500 comprises a gateway 510, client processing units 521, 522, . . . for purchase transactions, and a client processing unit 52n for accounting transactions. The gateway 510 can have a plurality of connections with the message-relay processing units 411, 412, . . . , 41n, which operate in the message relay device 400. The gateway 510 can designate the names of transactions so that the respective message-relay processing units 411, 412, . . . , 41n can recognize processing-request messages to be handled through the respective connections. In addition, the gateway 510 receives requests from the client processing units 521, 522, . . . for purchase transactions and requests from the client processing unit 52n for accounting transactions, recognizes transactions requested by the client processing units 521, 522, . . . , 52n, assigns the requests to respectively corresponding message-relay processing units, and transfers processing-request messages to the respectively corresponding message-relay processing units.

The client processing units 521, 522, . . . for purchase transactions output processing-request messages for purchase transactions in response to manipulation inputs by persons belonging to a purchase section 41. When the client processing units 521, 522, . . . receive processing-result messages, the client processing units 521, 522, . . . display the processing results. The client processing unit 52n for accounting transactions outputs processing-request messages for accounting transaction in response to manipulation inputs by a person belonging to an accounting section 42. When the client processing unit 52n receives a processing-result message, the client processing unit 52n displays the processing result.

As explained above, when a client of the gateway 510 has a transaction of one of the above types, the gateway 510 transfers a processing-request message to one of the message-relay processing units which can execute transaction processing in response to a request outputted from the client. In addition, the gateway 510 transfers a processing-result message from the message-relay processing unit, to the client which outputs the request. That is, since the gateway 510 assigns processing-request messages to the message-relay processing units 411, 412, . . . , 41n according to the types of transactions, the message relay device 400 controls the number of message-relay processing units for each type of transaction.

Further, according to the third embodiment, it is possible to execute message-relay processing by using at least one processing unit 110a each of which has functions similar to the functions illustrated in FIG. 5. That is, it is possible to use only one processing unit 110a and start more than one message-relay processing unit in the processing unit 110a, or use more than one processing unit 110a and start one or more message-relay processing unit in each processing unit 110a.

When a plurality of message-relay processing units are assigned to each type of processing regardless of the number of the processing units 110a, more than one message-relay processing unit stands ready for processing-request messages from clients related to each type of transaction. That is, even when the message relay device receives processing-request messages from more than one client, the message relay device can concurrently process the processing-request messages.

### Fourth Embodiment

The fourth embodiment of the present invention is a concrete example in which the present invention is applied to a nonstop type system.

When a system having a message relay device is used, sometimes it is necessary to change a parameter in the configuration file after the system is constructed, due to increase in the number of clients, increase in the number of requests from each client, and the like. In this case, after the parameter in the configuration file is corrected, it is necessary to stop and restart all of active message-relay processing units in order to load the corrected parameter in message-relay processing units. However, if all of the active message-relay processing units are stopped, it is impossible to process processing-request messages from clients until the active message-relay processing units are restarted. Nevertheless, in some systems of which 24-hour nonstop operation is required, even a stop for a short time as above is not tolerated. Therefore, according to the fourth embodiment, a plurality of processing units are started, and restart processing is performed on each processing unit in turn.

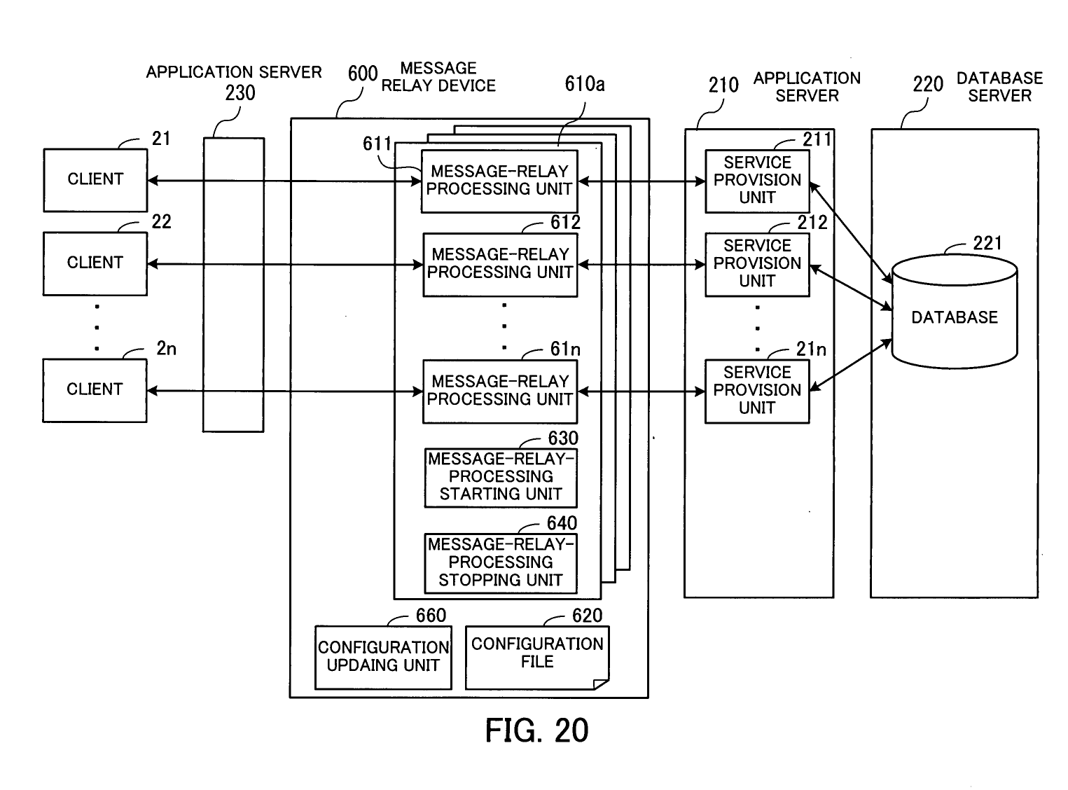

FIG. 20 is a diagram illustrating an example of a construction of a system of the fourth embodiment of the present invention. The fourth embodiment is different from the first embodiment (which is illustrated in FIG. 2) in the internal structure of the message relay device.

The message relay device 600 comprises a plurality of processing units 610a, a configuration file 620, and a configuration updating unit 660. Each of the plurality of processing units 610a contains one or more message-relay processing units 611, 612, . . . , 61n, a message-relay-processing starting unit 630, and a message-relay-processing stopping unit 640. Each of the message-relay processing units 611, 612, . . . , 61n, the configuration file 620, the message-relay-processing starting unit 630, and the message-relay-processing stopping unit 640 has a function which is identical to the element in the first embodiment (illustrated in FIG. 2) having the same name. That is, in each of the plurality of processing units 610a, one or more message-relay processing units are started.

The configuration updating unit 660 updates the contents of the configuration file 620 without stopping the message-relay functions in the message relay device 600. In addition, the configuration updating unit 660 loads the contents of the configuration file 620 in the processing units 610a.

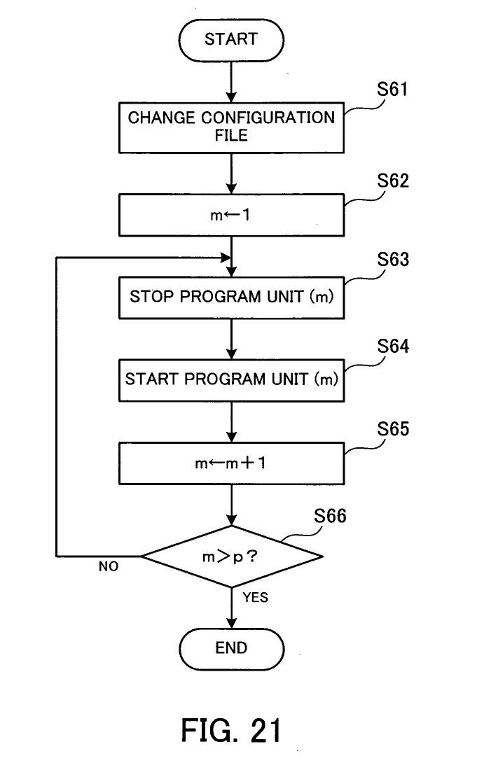

In the above system, the configuration is changed without stopping the message-relay functions as indicated below. FIG. 21 is a flow diagram illustrating processing for updating the configuration file according to the fourth embodiment. In the following explanations, the number of the processing units 610a is indicated by p (which is a positive integer), and identification numbers (processing unit numbers) 1, 2, . . . , p are assigned to the plurality of processing units 610a, respectively. The processing of FIG. 21 is explained below step by step.

[Step S61] The configuration updating unit 660 updates the contents of the configuration file 620 in response to a manipulation input or the like by a user.

[Step S62] The configuration updating unit 660 sets the variable m to one.

[Step S63] The configuration updating unit 660 stops one of the processing units 610a having the processing unit number m.

[Step S64] The configuration updating unit 660 starts one of the processing units 610a having the processing unit number m. At this time, the updated configuration file 620 is loaded based on the processing unit number m, so that the processing unit operates based on the updated configuration.

[Step S65] The configuration updating unit 660 increments the variable m by one.

[Step S66] The configuration updating unit 660 determines whether or not the variable m is greater than p. When yes is determined, the processing of FIG. 21 is completed. When no is determined, the operation goes to step S63, and another processing unit is restarted.

As explained above, the processing units are stopped and restarted one by one. Therefore, for example, even while one or more message-relay processing units in the processing unit having the processing unit number m are stopped, the other processing units are in operation. Thus, the entire system never stops, and the clients can send processing-request messages at any time. When each processing unit is restarted, the configuration of each message-relay processing unit in the processing unit is updated.

[Additional Matters]

The above processing functions can be realized by a computer. In this case, a program describing details of processing for realizing the functions which the message relay device should have is provided. When the computer executes the program, the above processing functions can be realized on the computer.

The program describing the details of the processing can be stored in a recording medium which can be read by the computer. The recording medium may be a magnetic recording device, an optical disk, an optical magnetic recording medium, a semiconductor memory, or the like. The magnetic recording device may be a hard disk drive (HDD), a flexible disk (FD), a magnetic tape, or the like. The optical disk may be a DVD (Digital Versatile Disk), a DVD-RAM (Random Access Memory), a CD-ROM (Compact Disk Read Only Memory), a CD-R (Recordable)/RW (ReWritable), or the like. The optical magnetic recording medium may be an MO (Magneto-Optical Disk) or the like.

In order to put the program into the market, for example, it is possible to sell a portable recording medium such as a DVD or a CD-ROM in which the program is recorded. Alternatively, it is possible to store the program in a storage device belonging to a server computer, and transfer the program to another computer through a network.

The computer which executes the program stores the program in a storage device belonging to the computer, where the program is originally recorded in, for example, a portable recording medium, or transferred from the server computer. The computer reads the program from the storage device, and performs processing in accordance with the program. Alternatively, the computer may directly read the program from the portable recording medium for performing processing in accordance with the program. Further, the computer can sequentially execute processing in accordance with each portion of the program when the portion of the program is transferred from the server computer.

As explained above, according to the present invention, when the number of processing-request messages which are concurrently processed by the message-relay processing units 1a, 1b, and 1c exceeds a threshold value for increase, at least one message-relay processing unit the number of which is predetermined is newly started. Therefore, when the number of concurrently processed processing-request messages is small, only a small number of message-relay processing units are activated, so that resources such as a memory can be efficiently used. On the other hand, when the number of concurrently processed processing-request messages is increased, increase in the clients' waiting times can be prevented by newly starting at least one message-relay processing unit before shortage of message-relay processing units occurs.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

1. A message relay program for relaying messages from at least one client by using a computer which is linked with the at least one client through at least one connection, said message relay program makes the computer execute processing comprising the steps of:
(a) starting at least one first message-relay processing unit, where the number of the at least one first message-relay processing unit is predetermined; and
(b) newly starting at least one second message-relay processing unit when the number of processing-request messages which are concurrently being processed by said at least one first message-relay processing unit exceeds a first predetermined threshold value, where the number of the at least one second message-relay processing unit is predetermined;
wherein said at least one first message-relay processing unit and said at least one second message-relay processing unit receive processing-request messages from said at least one client, transform the processing-request messages so as to have a predetermined data structure, transfer the transformed processing-request messages to a processing execution device, receive from the processing execution device processing-result messages respectively corresponding to the processing-request messages, and transfer the received processing-result messages to the at least one client.

2. The message relay program according to claim 1, wherein a predetermined value is added to said first predetermined threshold value when said at least one second message-relay processing unit is newly started.

3. The message relay program according to claim 1, wherein each of said at least one first message-relay processing unit and said at least one second message-relay processing unit has a status flag which indicates whether or not said each of the at least one first message-relay processing unit and the at least one second message-relay processing unit is currently executing processing of a processing-request message, and determines the number of processing-request messages which are concurrently being processed by said at least one first message-relay processing unit, by referring to the status flag of each of the at least one first message-relay processing unit.

4. The message relay program according to claim 3, wherein each of said at least one first message-relay processing unit and said at least one second message-relay processing unit has said status flag in a storage area which is shared by said each of the at least one first message-relay processing unit and the at least one second message-relay processing unit and a unit which executes said step (b).

5. The message relay program according to claim 1, wherein said processing further comprises a step (c) of stopping at least one third message-relay processing unit when the number of processing-request messages which are concurrently being processed by said at least one first message-relay processing unit becomes equal to or smaller than a second predetermined threshold value, where the number of the at least one third message-relay processing unit which is stopped is predetermined.

6. The message relay program according to claim 5, wherein a predetermined value is subtracted from said second predetermined threshold value when said at least one third message-relay processing unit is stopped.

7. The message relay program according to claim 5, wherein each of said at least one first message-relay processing unit and said at least one second message-relay processing unit has a stop-request-reception flag for receiving a stop request, and stops operation of said each of the at least one first message-relay processing unit and the at least one second message-relay processing unit after processing of a processing-request message which is already received is completed, when a value instructing said each of the at least one first message-relay processing unit and the at least one second message-relay processing unit to stop operation of said each of the at least one first message-relay processing unit and the at least one second message-relay processing unit is set in the stop-request-reception flag, and
when said at least one third message-relay processing unit is stopped, a value instructing the at least one third message-relay processing unit to stop operation of each of the at least one third message-relay processing unit is set in the stop-request-reception flag in said each of the at least one third message-relay processing unit.

8. The message relay program according to claim 1, wherein the number of the at least one first message-relay processing unit which is concurrently started in said step (a) does not exceed a maximum number which is preset.

9. The message relay program according to claim 1, wherein said at least one first message-relay processing unit, said at least one second message-relay processing unit, and a unit which executes said step (b) are contained in each of a plurality of processing units, at least one of the plurality of processing units is concurrently activated, said steps (a) and (b) are executed in each of the at least one of the plurality of processing units which is concurrently activated, said processing further comprises a step (d) of restarting a plurality of processing units in turn when a configuration definition is changed, and said configuration definition contains said first predetermined threshold value and the number of said at least one second message-relay processing unit which are newly started in step (b), and is loaded on startup of each of said plurality of processing units.

10. A message relay method performed in a device for relaying messages from at least one client which is linked with the device through at least one connection, comprising the steps of:
(a) starting at least one first message-relay processing unit, where the number of the at least one first message-relay processing unit is predetermined; and
(b) newly starting at least one second message-relay processing unit when the number of processing-request messages which are concurrently being processed by said at least one first message-relay processing unit exceeds a first predetermined threshold value, where the number of the at least one second message-relay processing unit is predetermined;
wherein said at least one first message-relay processing unit and said at least one second message-relay processing unit receive processing-request messages from said at least one client, transform the processing-request messages so as to have a predetermined data structure, transfer the transformed processing-request messages to a processing execution device, receive from the processing execution device processing-result messages respectively corresponding to the processing-request messages, and transfer the received processing-result messages to the at least one client.

11. A message relay device for relaying messages from at least one client which is linked with the message relay device through at least one connection, comprising:
at least one first message-relay processing unit which is active; and
a message-relay-processing starting unit which newly starts at least one second message-relay processing unit when the number of processing-request messages which are concurrently being processed by said at least one first message-relay processing unit exceeds a predetermined threshold value;
wherein the number of the at least one second message-relay processing unit which is newly started by said message-relay-processing starting unit is predetermined, and said at least one first message-relay processing unit and said at least one second message-relay processing unit receive processing-request messages from said at least one client, transform the processing-request messages so as to have a predetermined data structure, transfer the transformed processing-request messages to a processing execution device, receive from the processing execution device processing-result messages respectively corresponding to the processing-request messages, and transfer the received processing-result messages to the at least one client.

12. A computer-readable storage medium storing a message relay program for relaying messages from at least one client by using a computer which is linked with the at least one client through at least one connection, said message relay program makes the computer execute processing comprising the steps of:
(a) starting at least one first message-relay processing unit, where the number of the at least one first message-relay processing unit is predetermined; and
(b) newly starting at least one second message-relay processing unit when the number of processing-request messages which are concurrently being processed by said at least one first message-relay processing unit exceeds a first predetermined threshold value, where the number of the at least one second message-relay processing unit is predetermined;
wherein said at least one first message-relay processing unit and said at least one second message-relay processing unit receive processing-request messages from said at least one client, transform the processing-request messages so as to have a predetermined data structure, transfer the transformed processing-request messages to a processing execution device, receive from the processing execution device processing-result messages respectively corresponding to the processing-request messages, and transfer the received processing-result messages to the at least one client.
